(19) United States
(12) Patent Application Publication
(10) Pub. No.: US 2023/0217274 A1
(43) Pub. Date: Jul. 6, 2023

(54) BEAM FAILURE RECOVERY IN A CELL THAT INCLUDES MULTIPLE TRANSMISSION AND RECEPTION POINTS

(71) Applicant: Apple Inc., Cupertino, CA (US)

(72) Inventors: Fangli Xu, Beijing (CN); Haijing Hu, Los Gatos, CA (US); Wei Zeng, Saratoga, CA (US); Yuqin Chen, Beijing (CN); Yushu Zhang, Beijing (CN)

(73) Assignee: Apple Inc., Cupertino, CA (US)

(21) Appl. No.: 18/078,908

(22) Filed: Dec. 9, 2022

Related U.S. Application Data
(60) Provisional application No. 63/296,758, filed on Jan. 5, 2022.

(51) Int. Cl. H04W 24/04; H04W 24/08; H04B 7/022

(52) U.S. Cl. CPC H04W 24/04; H04W 24/08; H04B 7/022

(57) ABSTRACT

The present application relates to beam failure recovery in a cell that includes multiple transmission and reception points (TRPs). In an example, a UE can perform a beam failure detection (BFD) procedure to detect, per TRP, whether a beam failure occurs. The UE can also perform one or more beam failure recovery (BFR) procedures based on the number of beam failures, the type of cell, and/or other related information.

### CROSS-REFERENCES TO RELATED APPLICATION

This application claims priority from U.S. Provisional Patent Application No. 63/296,758, filed Jan. 5, 2022, the entire contents of which is herein incorporated by reference for all purposes.

### TECHNICAL FIELD

The present application relates to the field of wireless technologies and, in particular, to beam failure recovery in a cell that includes multiple transmission and reception points.

### BACKGROUND

Fifth generation mobile network (5G) is a wireless standard that aims to improve upon data transmission speed, reliability, availability, and more. This standard, while still developing, includes numerous details related to, for instance, a user equipment (UE) communicating with a transmission and reception point (TRP) of a network to send and receive data. The communication can rely over one or more channels available from one or more beams provided by the TRP and detected by the UE.

### BRIEF DESCRIPTION OF THE DRAWINGS

FIG. 1 illustrates an example of a network environment, in accordance with some embodiments.

FIG. 2 illustrates an example of a cell that includes multiple transmission and reception points (TRPs), in accordance with some embodiments.

FIG. 3 illustrates an example of a cell beam failure recovery (BFR) procedure, in accordance with some embodiments.

FIG. 4 illustrates an example of a TRP BFR procedure, in accordance with some embodiments.

FIG. 5 illustrates an example of using a TRP BFR procedure and a cell BFR procedure in a cell that includes multiple TRPs, in accordance with some embodiments.

FIG. 6 illustrates another example of using a cell BFR procedure in a cell that includes multiple TRPs, in accordance with some embodiments.

FIG. 7 illustrates an example of using a TRP BFR procedure and canceling a cell BFR procedure in a cell that includes multiple TRPs, in accordance with some embodiments.

FIG. 8 illustrates another example of using a TRP BFR procedure and canceling a cell BFR procedure in a cell that includes multiple TRPs, in accordance with some embodiments.

FIG. 9 illustrates an example of canceling a cell BFR procedure in a cell that includes multiple TRPs, in accordance with some embodiments.

FIG. 10 illustrates an example of canceling a TRP BFR procedure and using a cell BFR procedure in a cell that includes multiple TRPs, in accordance with some embodiments.

FIG. 11 illustrates another example of canceling a TRP BFR procedure and using a cell BFR procedure in a cell that includes multiple TRPs, in accordance with some embodiments.

FIG. 12 illustrates an example of using multiple TRP BFR procedures in a cell that includes multiple TRPs, in accordance with some embodiments.

FIG. 13 illustrates another example of using a TRP BFR procedure and canceling another TRP BFR procedure in a cell that includes multiple TRPs, in accordance with some embodiments.

FIG. 14 illustrates an example of an enhanced BFR media access control (MAC) control element (CE) usable to send BFR information to a network, in accordance with some embodiments.

FIG. 15 illustrates another example of an enhanced BFR MAC CE usable to send BFR information to a network, in accordance with some embodiments.

FIG. 16 illustrates yet another example of an enhanced BFR MAC CE usable to send BFR information to a network, in accordance with some embodiments.

FIG. 17 illustrates an example of an operational flow/algorithmic structure for beam failure recovery in a cell that includes multiple TRPs, in accordance with some embodiments.

FIG. 18 illustrates an example of an operational flow/algorithmic structure for canceling a cell BFR procedure, in accordance with some embodiments.

FIG. 19 illustrates an example of an operational flow/algorithmic structure for initiating a cell BFR procedure, in accordance with some embodiments.

FIG. 20 illustrates an example of receive components, in accordance with some embodiments.

FIG. 21 illustrates an example of a UE, in accordance with some embodiments.

FIG. 22 illustrates an example of a base station, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Generally, a user equipment (UE) can communicate with a network, such as with a transmission and reception point (TRP) of a cell. To improve data throughput, a multiple input multiple output (MIMO) implementation can be used, where the UE can communicate with two or more TRPs of the cell. In the MIMO implementation, the communication with a TRP can rely on one or more channels that are available from a beam provided by the TRP and detected by the UE. The UE can support beam management at a TRP level, such that the UE can use the best possible beam in its communication with each TRP.

As part of the beam management, the UE can perform a beam failure detection (BFD) procedure to detect, per TRP, whether a beam failure exists and can perform a beam failure recovery (BFR) procedure as needed. The UE may support multiple BFR procedure types and can be configured to do so by the network. An example type is a TRP BFR procedure that is at a TRP level and that involves sending a BFR request to the network, receiving a first uplink grant from the network, transmitting BFR information to the network based on the first uplink grant, and receiving a second uplink grant. Another type is a cell BFR procedure that is at a cell level and that involves a random access channel (RACH) procedure (contention free or contention based). Depending on the configuration, the type of the cell (e.g., a special cell (SpCell), such as primary Cell (PCell) or a primary secondary cell group cell (PSCell), or a secondary cell (SCell)), the number of simultaneously failed beams, and/or other information, the UE can initiate one or more BFR procedures (e.g., a cell BFR procedure, and/or or one or more TRP BFR procedures). Furthermore, when multiple BFR procedures are being performed in parallel, and depending on an opportunity to use one of these procedures to send BFR information to the network, a remaining BFR procedure(s) can be canceled. The BFR information can be transmitted in a media access control (MAC) control element (CE) that includes fields for reporting the BFR information at a TRP level. This MAC CE can be referred to herein as an enhanced MAC CE. These and other features related to the beam management in a cell that includes a plurality of TRPs are further described herein below.

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or digital signal processors (DSPs) that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to and may be referred to as client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “TRP” as used herein refers to a device with radio communication capabilities that is a network node of a communications network (or, more briefly, network) and that may be configured as an access node in the communications network. A UE's access to the communications network may be managed at least in part by the TRP, whereby the UE connects with TRP to access the communications network. Depending on the radio access technology (RAT), the TRP can have a number of transmit and receive antenna elements generating directional beams.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like, as used herein, refer to the creation of an instance. An “instance” also refers to a concrete occurrence of an object, which may occur, for example, during execution of program code.

The term “connected” may mean that two or more elements at a common communication protocol layer have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

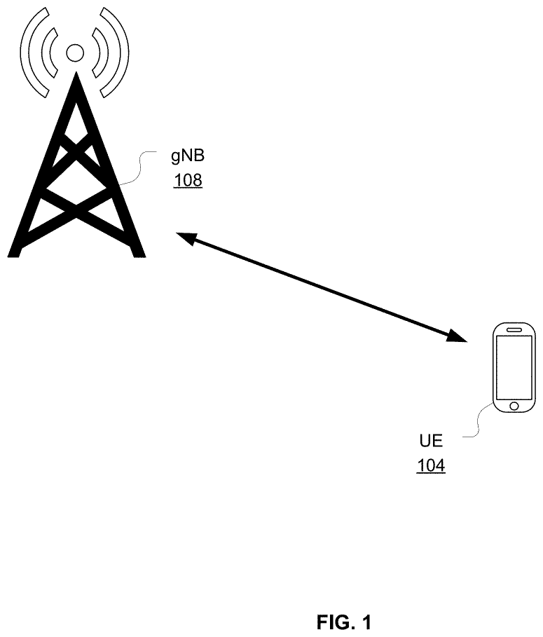

FIG. 1 illustrates a network environment 100, in accordance with some embodiments. The network environment 100 may include a UE 104 and a gNB 108. The gNB 108 may be a base station that provides a wireless access cell, for example, a Third Generation Partnership Project (3GPP) New Radio (NR) cell, through which the UE 104 may communicate with the gNB 108. The UE 104 and the gNB 108 may communicate over an air interface compatible with 3GPP technical specifications, such as those that define Fifth Generation (5G) NR system standards. As further described in the next figures, the gNB 108 can be deployed as a TRP in a cell that includes multiple TRPs.

The gNB 108 may transmit information (for example, data and control signaling) in the downlink direction by mapping logical channels on the transport channels and transport channels onto physical channels. The logical channels may transfer data between a radio link control (RLC) and MAC layers; the transport channels may transfer data between the MAC and PHY layers; and the physical channels may transfer information across the air interface. The physical channels may include a physical broadcast channel (PBCH), a physical downlink control channel (PDCCH), and a physical downlink shared channel (PDSCH).

The PBCH may be used to broadcast system information that the UE 104 may use for initial access to a serving cell. The PBCH may be transmitted along with physical synchronization signals (PSS) and secondary synchronization signals (SSS) in an SSB. The SSBs may be used by the UE 104 during a cell search procedure (including cell selection and reselection) and for beam selection.

The PDSCH may be used to transfer end-user application data, signaling radio bearer (SRB) messages, system information messages (other than, for example, MIB), and SIs.

The PDCCH may transfer DCI that is used by a scheduler of the gNB 108 to allocate both uplink and downlink resources. The DCI may also be used to provide uplink power control commands, configure a slot format, or indicate that preemption has occurred.

The gNB 108 may also transmit various reference signals to the UE 104. The reference signals may include demodulation reference signals (DMRSs) for the PBCH, PDCCH, and PDSCH. The UE 104 may compare a received version of the DMRS with a known DMRS sequence that was transmitted to estimate an impact of the propagation channel. The UE 104 may then apply an inverse of the propagation channel during a demodulation process of a corresponding physical channel transmission.

The reference signals may also include channel status information reference signals (CSI-RS). The CSI-RS may be a multi-purpose downlink transmission that may be used for CSI reporting, beam management, connected mode mobility, radio link failure detection, beam failure detection and recovery, and fine-tuning of time and frequency synchronization.

The reference signals and information from the physical channels may be mapped to resources of a resource grid. There is one resource grid for a given antenna port, subcarrier spacing configuration, and transmission direction (for example, downlink or uplink). The basic unit of an NR downlink resource grid may be a resource element, which may be defined by one subcarrier in the frequency domain and one orthogonal frequency division multiplexing (OFDM) symbol in the time domain. Twelve consecutive subcarriers in the frequency domain may compose a physical resource block (PRB). A resource element group (REG) may include one PRB in the frequency domain and one OFDM symbol in the time domain, for example, twelve resource elements. A control channel element (CCE) may represent a group of resources used to transmit PDCCH. One CCE may be mapped to a number of REGs, for example, six REGs.

The UE 104 may transmit data and control information to the gNB 108 using physical uplink channels. Different types of physical uplink channels are possible including, for instance, a physical uplink control channel (PUCCH) and a physical uplink shared channel (PUSCH). Whereas the PUCCH carries control information from the UE 104 to the gNB 108, such as uplink control information (UCI), the PUSCH carries data traffic (e.g., end-user application data) and can carry UCI.

The UE 104 and the gNB 108 may perform beam management operations to identify and maintain desired beams for transmission in the uplink and downlink directions. The beam management may be applied to both PDSCH and PDCCH in the downlink direction and PUSCH and PUCCH in the uplink direction.

In an example, communications with the gNB 108 and/or the base station can use channels in the frequency range 1 (FR1), frequency range 2 (FR2), and/or a higher frequency range (FRH). The FR1 band includes a licensed band and an unlicensed band. The NR unlicensed band (NR-U) includes a frequency spectrum that is shared with other types of radio access technologies (RATs) (e.g., LTE-LAA, WiFi, etc.). A listen-before-talk (LBT) procedure can be used to avoid or minimize collision between the different RATs in the NR-U, whereby a device should apply a clear channel assessment (CCA) check before using the channel.

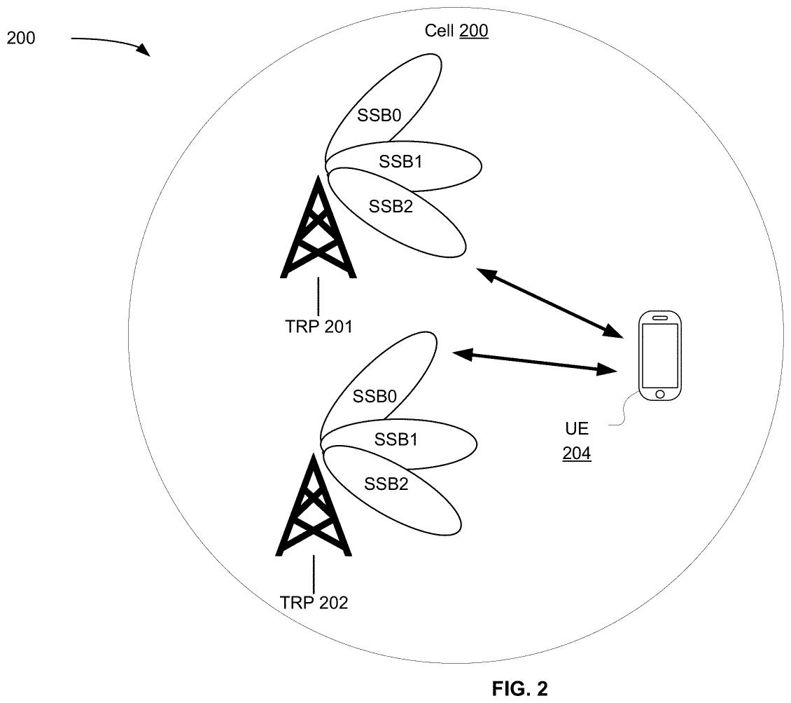

FIG. 2 illustrates an example of a cell 200 that includes multiple TRPs, in accordance with some embodiments. In the illustration, the cell 200 includes two TRPs: a first TRP 201 and a second TRP 202. Nonetheless, a larger number of TRPs is possible. Generally, the cell 200 is a serving cell that enables MIMO communications, where a UE 204 can simultaneously communicate with the TRP 201 and TRP 202 to simultaneously transmit and/or simultaneously receive information (e.g., traffic data). Each TRP of the cell 200 can transmit multiple directional beams (FIG. 2 illustrates three beams labeled as synchronization signal blocks (SSBs) “0” through “2”), although a different number of directional beams is possible and can extend to cover a sphere-like shape around the TRP. Based on beam measurements, such as reference signal received power (RSRP) and/or reference signal received power quality (RSRQ), the UE 204 can select a particular beam transmitted by a TRP in support of the communication therewith. In the illustration of FIG. 2, the UE 204 communicates with TRP 201 using SSB2 and with TRP 202 using SSB0.

In the case of carrier aggregation, the network can configure the cell 200 as a PCell or an SCell. In the case of dual connectivity, the network can configure the cell 200 as a PCell, a PSCell, or an SCell. As used herein, an SpCell refers to either a PCell or a PSCell.

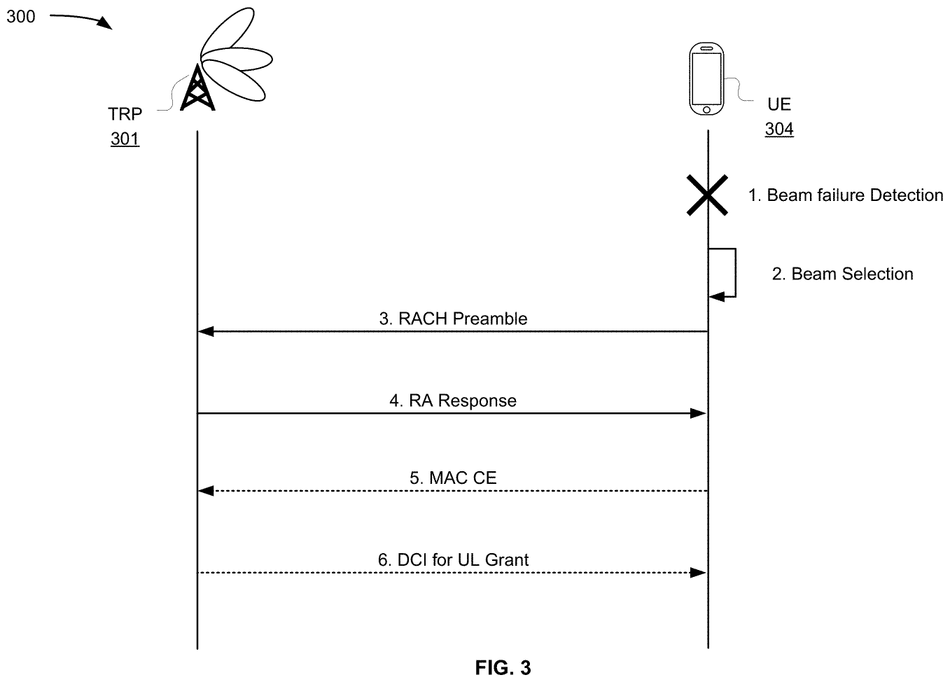

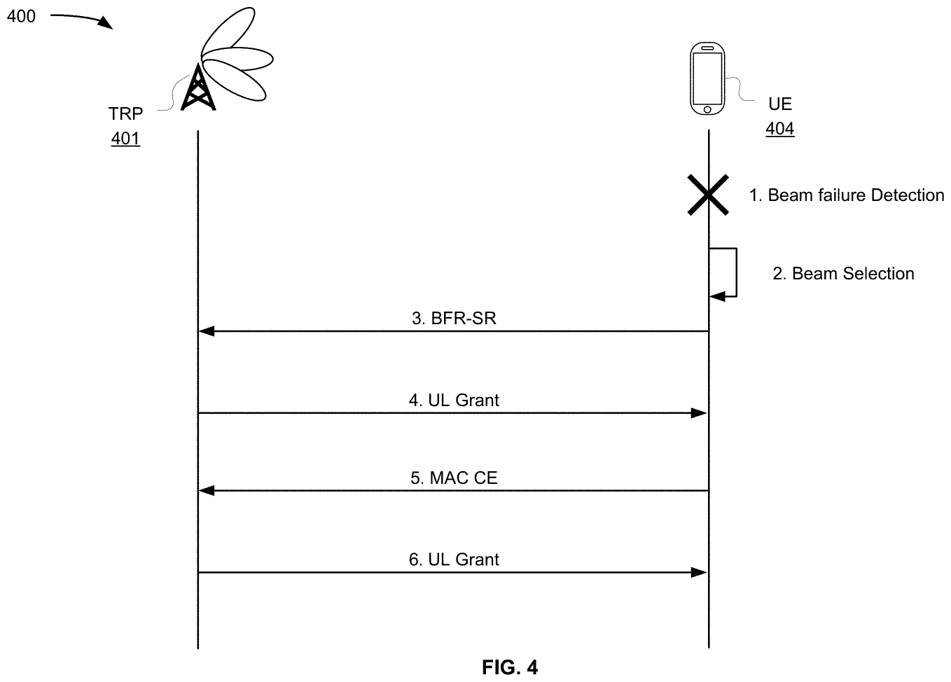

The network can configure the UE 204 to communicate with the TRP 201 and TRP 202 by sending, to the UE 203, configuration information (e.g., via RRC messages). The configuration information can indicate, among other things, BFD reference signal (RS) sets to use as part of beam management. The configuration information can enable the UE 204 to detect a beam failure at a TRP level and/or a cell level. The configuration information can also enable the UE to perform a cell BFR procedure and/or a TRP BFR procedure. Generally, the cell BFR procedure can be more robust (e.g., in a noisy RF environment) than the TRP BFR procedure, whereas the TRP BFR procedure can have a lower latency than the cell BFR procedure. Absent a configured BFD-RS set, the UE 204 may not be enabled to perform a TRP BFR procedure and may instead perform a RACH procedure. An example of the cell BFR procedure is further described in FIG. 3. An example of the TRP BFR procedure is further described in FIG. 4.

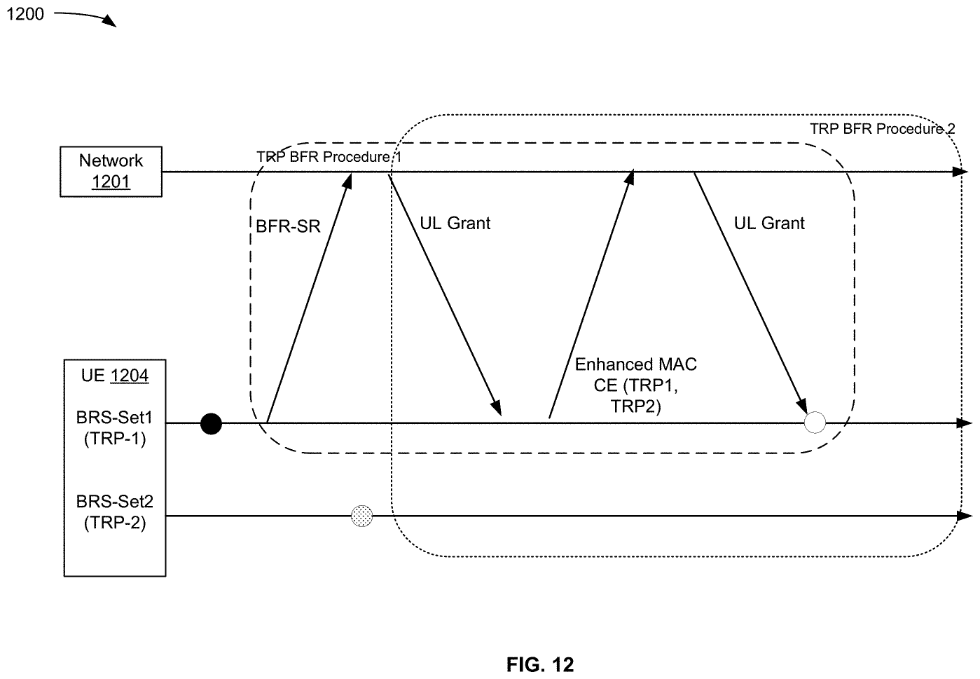

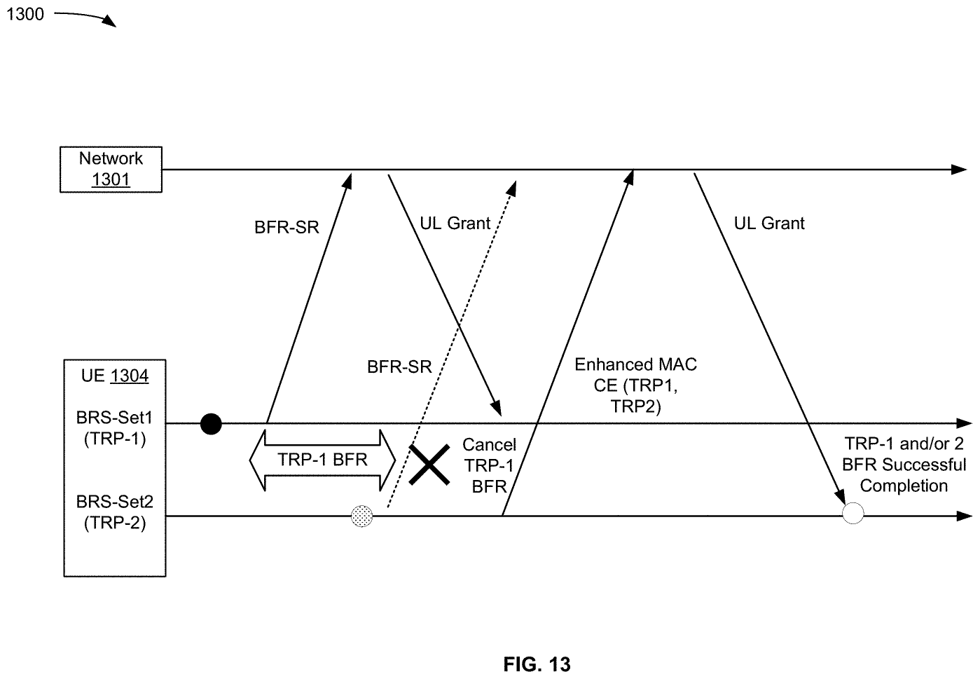

FIG. 3 illustrates an example 300 of a cell BFR procedure, in accordance with some embodiments. The cell BFR procedure can be performed when the serving cell is an SpCell and, thus, may be referred to herein an SpCell-specific BFR procedure. Nonetheless, it is possible to use the SpCell BFR procedure for beam failures in an SCell as further described in connection with FIGS. 12 and 13.

In the example 300, a TRP 301 of a serving cell and a UE 304 communicates using a beam. The serving cell can be an SpCell. The UE 304 performs a BFD procedure to detect a failure of the beam. The BFD procedure can be a combined L1/L2 procedure, where the physical (PHY) layer provides, to the MAC layer, indications of beam failure instances (BFIs). For instance, the PHY layer detects that a measurement on a reference signal sent over the beam (e.g., RSRP of the reference signal of the serving beam) is below a configured threshold value and, accordingly, indicates a BFI to the MAC layer. The MAC layer counts the indications and declares failure when a network-configured maximum number of BFI indications has been reached. For instance, the MAC layer increments a BFI COUNTER corresponding to the serving cell by “1.” If the BFI_COUNTER is equal to or exceeds a BeamFailureInstanceMaxCount corresponding to the serving cell, the MAC layer can trigger the BFR procedure for the serving cell.

The UE 304 is provided with a set of resources for the BFR procedure in, for instance, the BeamFailureRecoveryConfig via RRC message. These resources can include one or more beam reference signal (BRS) sets. The UE 304 can perform measurements (e.g., RSRP measurements) on detected beams of the TRP 301 using the set of resources to select the best candidate beam for the cell BFR procedure. Generally, the cell BFR procedure includes performing RACH procedure on the best candidate beam. The RACH procedure can be referred to herein as a BFR RACH procedure and includes sending a RACH preamble that indicates a beam failure recovery request (BFRQ).

Two RACH procedures are possible for the SpCell BFR procedure: contention free random access (CFRA RACH) illustrated with the two solid arrows with the numeral labels “3” and “4,” and a contention based random access (CBRA RACH) illustrated with the two solid arrows with the numeral labels “3” and “4” and the two dotted arrows with the number labels “5” and “6.” The UE 304 performs the CBRA RACH if not configured with CFRA RACH resources, if it has been configured with CFRA RACH but was unable to perform CFRA RACH due to the unavailability of the candidate beams, or if the CFRA RACH was unsuccessfully performed. In the CBRA RACH procedure, the UE 304 sends a MAC CE to the network to indicate that the random access is for BFR purposes. The BFR MAC CE can carry the BFR information of multiple serving cells (including the failed serving cell information and candidate beam information).

As illustrated, both types of RACH procedures include the UE 304 first sending a RACH preamble to the network and receiving back a random access response. The CBRA RACH further includes sending the BFR MAC CE (e.g., in a Msg3 or MsgA) and receiving back DCI for an uplink grant from the network.

When the serving cell is an SCell, the SpCell BFR procedure need not be used. Instead, an SCell BFR procedure can be used. In the SCell BFR procedure, the UE 304 sends the BFR MAC CE to the network. If UE 304 receives back the L1 ACK/DS for new transmission for the same HARQ process for the BFR MAC CE transmission, the UE 304 determines that the SCell BFR procedure is completed successfully.

FIG. 4 illustrates an example 400 of a TRP BFR procedure, in accordance with some embodiments. The TRP BFR procedure can be performed at a TRP level within a serving cell, where the serving cell can be an SpCell or an SCell. Unlike the SpCell BFR procedure that is described herein above and that includes a RACH procedure, the TRP BFR procedure can exclude the RACH procedure. When a BFR-SR set is configured, the TRP BFR procedure can be performed. Otherwise, the RACH procedure is triggered.

In the example 400, a TRP 401 of a serving cell and a UE 404 communicate using a beam. The serving cell can be an SCell. The UE 404 performs a BFD procedure to detect a failure of the beam to then trigger the TRP BFR procedure. Upon the detection of the beam failure, the UE 404 can also select the best candidate beam to use for the TRP BFR procedure. This procedure includes sending, to the network a BFRQ (optionally) and a MAC CE indicating the BFR information associated with the detected beam failure (e.g., a BFR MAC CE indicating the TRP and beam information for the beam recovery). When the beam failure occurs, if an available uplink resource grant exists, the UE 404 transmits the BFR MAC CE in a PUSCH transmission to report the beam failure and a selected new beam (e.g., the BFR procedure can skip sending, by the UE 404, a BFR scheduling request (BFR-SR) and receiving back an uplink grant illustrated with the arrows labeled with numerals “3” and “4”). If no such uplink resource grant exists, the UE 404 can send the BFR-SR in the PUCCH to request an uplink grant for sending the BFR MAC CE (as indicated with the arrow labeled with number “3”). Upon receiving the uplink grant (as indicated with the arrow labeled with number “3”), the UE 404 can send the BFR MAC CE to the network by using the granted uplink resource (as indicated with the arrow labeled with number “5”) and then receives back a uplink (e.g., based on DCI) for transmission on a channel on the beam to use (as indicated with the arrow labeled with number “6”). If no uplink resource is granted and/or the network has not configured the UE 404 for the TRP BFR procedure (e.g., by not providing the relevant SR configuration), the UE 404 can trigger a RACH procedure as described herein above with the SpCell BFR procedure.

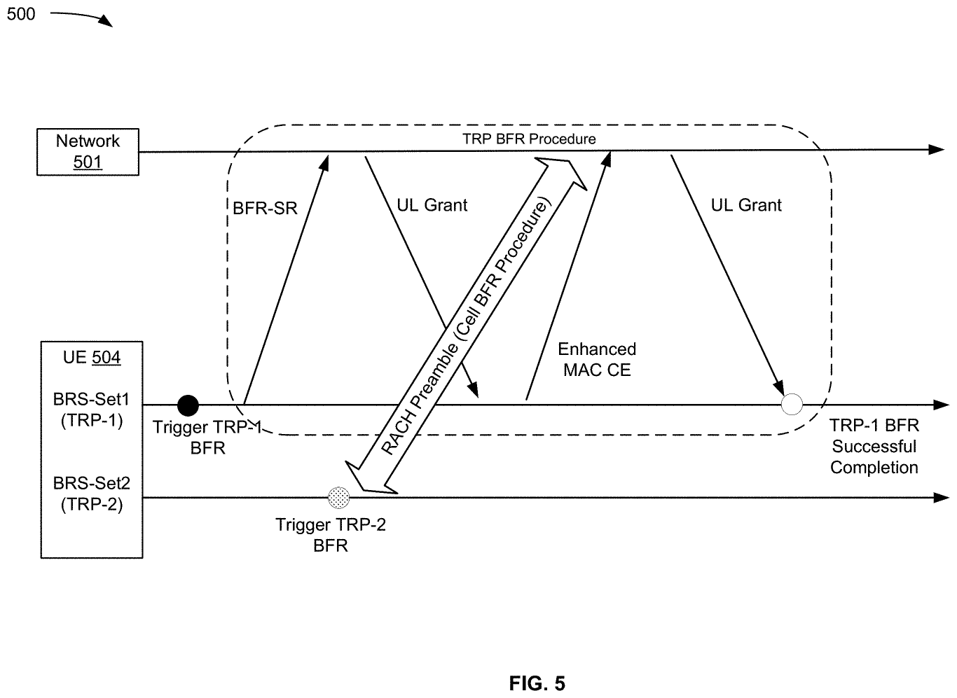

FIG. 5 illustrates an example 500 of using a TRP BFR procedure and a cell BFR procedure in a cell that includes multiple TRPs, in accordance with some embodiments. As indicated above, the TRP BFR procedure excludes a RACH procedure, whereas the cell BFR procedure includes the RACH procedure. As such, the TRP BFR procedure can have a relatively lower latency, whereas the cell BFR procedure can be relatively more robust. A network 501 can configure a UE 504 (e.g., by sending configuration information using RRC messages) to use the TRP BFR procedure and/or the cell BFR procedure. In turn, the UE 504 can initiate the TRP BFR procedure and/or the cell BFR procedure upon detecting one or more beam failures associated with one or more TRPs of a serving cell. The UE 504 can use a number of factors, some of which can be configured by the network 501, to select the BFR procedure type to use. The factors illustrated by example 500 of FIG. 5 include the serving cell type, the configured BFR procedure type(s), and the number of simultaneously detected beam failures.

In example 500, the serving cell is an SpCell (in which case, the cell BFR procedure can be referred to as an SpCell BFR procedure as explained herein above). The network 501 has also configured the UE 504 to use both types of BFR procedures. Upon detecting a first beam failure associated with a first TRP of the SpCell, the UE 504 initiates the TRP BFR procedure. Upon detecting a second beam failure associated with a second TRP of the SpCell, where this second beam failure triggers a beam recovery prior to the completion of the TRP BFR procedure, the UE 504 can initiate the SpCell BFR procedure instead of initiating another TRP BFR procedure. That can be advantageous because the simultaneous beam failures across the two TRPs can correspond to a noisy environment and hinder communications of the UE 504 in the SpCell and, thereby, justify the overhead used in also initiating and using the RACH procedure of the SpCell BFR procedure.

In the illustration of FIG. 5, the UE 504 is configured with a first BRS set that corresponds to the first TRP and a second BRS set that corresponds to the second TRP (shown as BRS-Set1 and BRS-Set2). Of course, if additional TRPs exist in the SpCell, additional BRS sets can be configured for the UE. Each BRS set is usable to perform a TRP BFR procedure for beam recovery with the associated TRP.

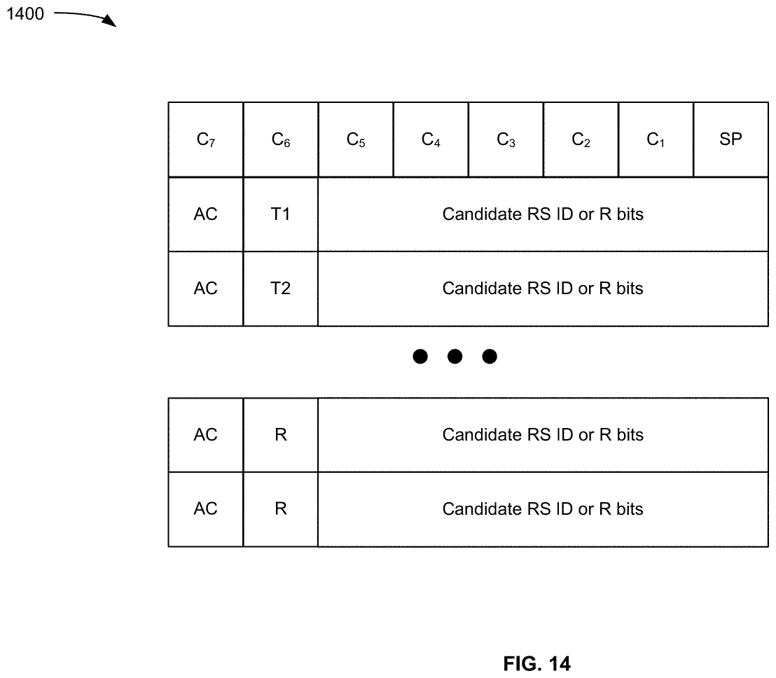

A first beam failure detection associated with the first TRP can be a trigger to perform a BFR procedure (e.g., a first TRP BFR procedure). At this point (illustrated with a solid dark circle in FIG. 5), the UE 504 can determine that no other beam failure is also detected and/or another TRP BFR procedure is ongoing. Accordingly, the UE 504 performs the first TRP BFR procedure that includes sending a BFR-SR to the network 501, receiving back an uplink grant, sending an enhanced MAC CE to the network based on the uplink grant, and receiving back an uplink grant indicating a channel for use on a recovered beam (at which point a successful completion of the TRP BFR procedure is determined and is shown in FIG. 5 with a blank circle). This procedure is similar to the TRP BFR procedure described in FIG. 4. Examples of the enhanced MAC CE are further described in the next figures, including FIGS. 14-16.

At some point between the initiation and the completion of the TRP BFR procedure, the UE 504 detects a second beam failure associated with the second TRP. This point is illustrated with a dot-filled circle in FIG. 5 and corresponds to a second trigger to perform a BFR procedure (e.g., a second TRP BFR procedure). Here, the UE can determine that the first beam failure is also detected and/or that the first TRP BFR procedure is ongoing. Accordingly, rather than performing the second TRP BFR procedure that relies on the second BSR set, the UE 504 initiates the SpCell BFR procedure. This SpCell BFR includes a RACH procedure (that may be CBRA or CFRA depending on how the network 501 configured the UE 504) that involves sending a RACH preamble to the network 501.

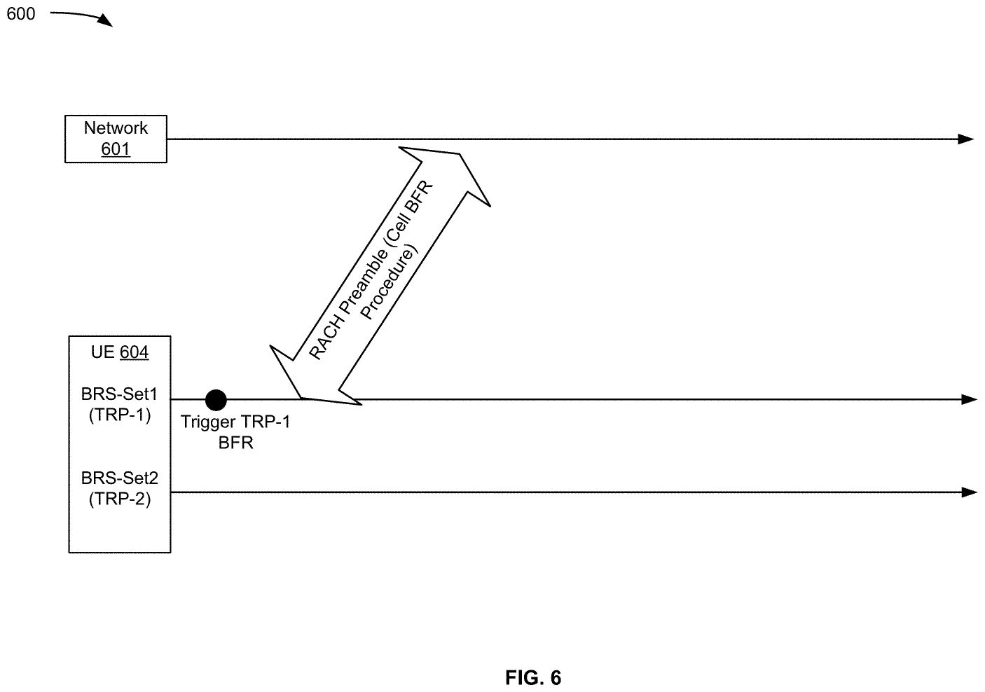

FIG. 6 illustrates another example 600 of using a cell BFR procedure in a cell that includes multiple TRPs, in accordance with some embodiments. Like the example 500 of FIG. 5, a UE 604 can communicate with a network 601 via two TRPs of a serving cell (the communications are shown with the two bottom arrows). The serving cell can be an SpCell. However, unlike the example 500 of FIG. 5, the network 601 does not configure a TRP BFR-SR for the UE 604 to use in a TRP BFR procedure. In this case, the UE 604 can rely on a cell BFR procedure. As such here, upon a beam failure being detected in association with a TRP, the UE 604 can initiate the cell BFR procedure (e.g., an SpCell BFR procedure) regardless of the total number of detected beam failures.

As illustrated, a beam failure detection associated with the first TRP can be a trigger to perform a BFR procedure. At this point (illustrated with a solid dark circle in FIG. 6), the UE 604 may have determined that no other beam failure is also detected and/or another BFR procedure is ongoing, or, alternatively, that another beam failure is also detected and/or another BFR procedure is ongoing. Accordingly, the UE 604 initiates the SpCell BFR procedure. This SpCell BFR includes a RACH procedure (that may be CBRA or CFRA depending on how the network 601 configured the UE 604) that involves sending a RACH preamble to the network 601.

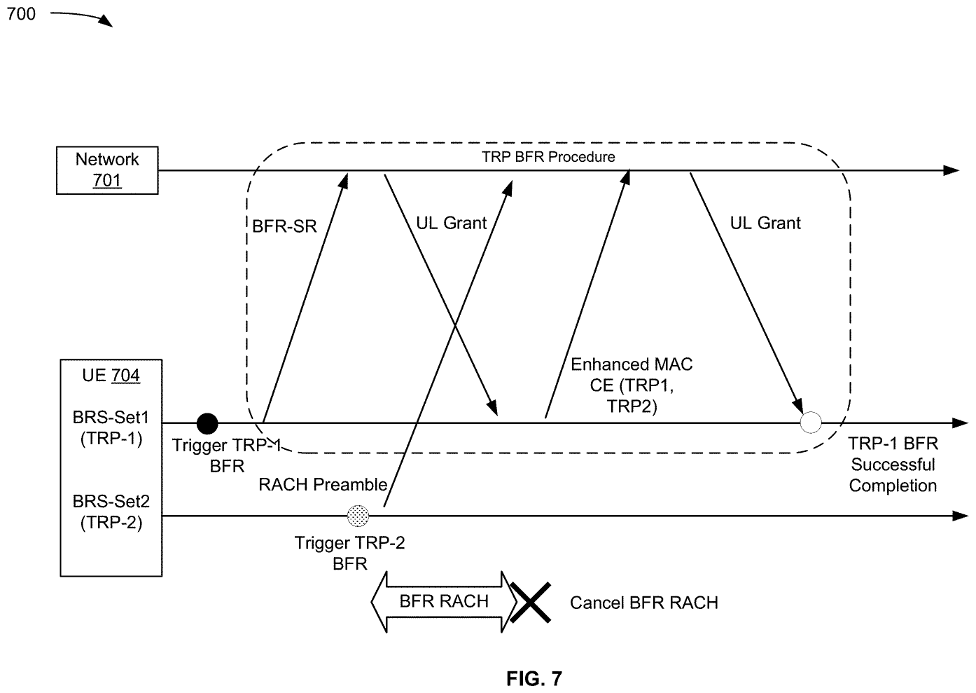

FIG. 7 illustrates an example 700 of using a TRP BFR procedure and canceling a cell BFR procedure in a cell that includes multiple TRPs, in accordance with some embodiments. As described in connection with FIG. 5, both BFR procedures can be initiated and their performance can overlap at least in part over time. Because the cell BFR procedure can involve relatively more overhead, canceling it can be advantageous as long as BFR information for recovering the beam failures is sent to a network 701. As such, when both BFR procedures are ongoing, a UE 704 can determine an opportunity to cancel the cell BFR procedure and does so upon the opportunity being determined. Different opportunity types are possible. The example 700 of FIG. 7 corresponds to one possible opportunity.

Similar to the example 500 of FIG. 5, the network 701 can configure the UE 704 to use a first TRP BFR procedure, a second TRP BFR procedure, and a cell BFR procedure in an SpCell. Upon detecting a first beam failure associated with a first TRP of the SpCell (a first trigger illustrated with a solid dark circle in FIG. 7), the UE 704 initiates the first TRP BFR procedure. Upon detecting a second beam failure associated with a second TRP of the SpCell, where this second beam failure (a second trigger illustrated with a dot-filled circle in FIG. 7) triggers a beam recovery prior to the completion of the first TRP BFR procedure, the UE 704 can initiate the SpCell BFR procedure instead of the second TRP BFR procedure.

In the illustration of FIG. 7, the first TRP BFR procedure includes the UE 704 receiving a dedicated uplink grant from the network 701 in response to sending a BFR-RS. The uplink grant is received after the second trigger (e.g., after the UE 704 triggers the RACH procedure for the BFR and sends a RACH preamble) and before the first BFR information associated with the first TRP is sent (e.g., an enhanced MAC CE is not set per the first TRP BFR procedure, or sent in a Msg3/MsgA of the RACH procedure). As such, the UE 704 can include the first BFR information and second BFR information associated with the second TRP in the to-be-sent enhanced MAC CE. This potential enhanced MAC CE transmission is an opportunity to cancel the BFR RACH procedure (e.g., the RACH procedure of the SpCell BFR procedure). Accordingly, the UE 704 cancels the BFR RACH procedure, and continues the processing of the first TRP BFR procedure. The UE 704 can include the first BFR information and the second BFR information in the enhanced MAC CE and sends this BFR enhanced MAC CE on the granted uplink resource to the network 701 to receive back an uplink grant and successfully complete the first TRP BFR procedure (illustrated with a blank circle in FIG. 7).

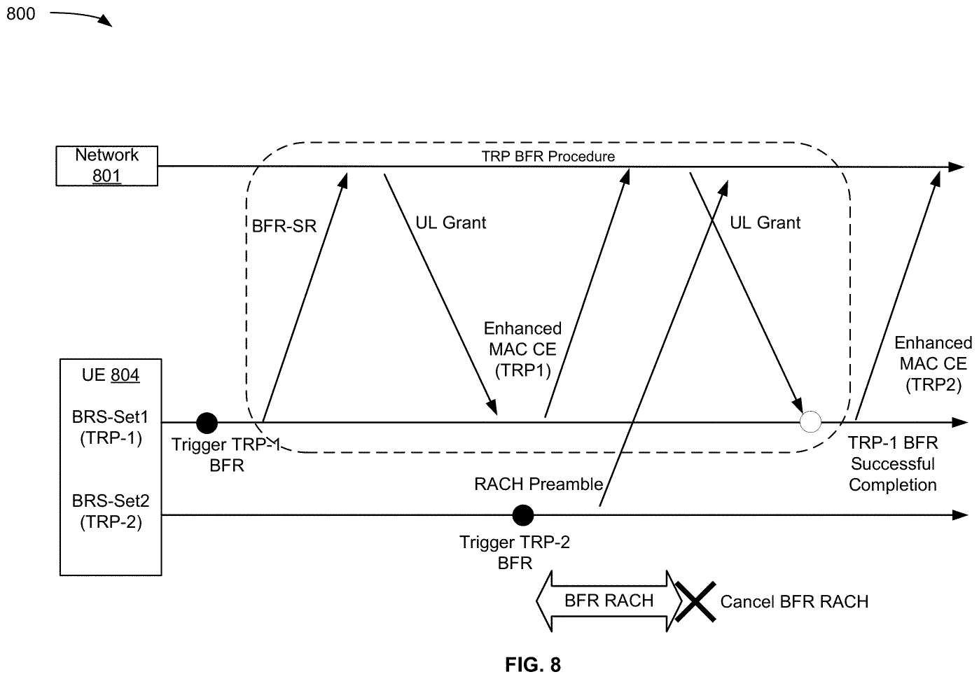

FIG. 8 illustrates another example 800 of using a TRP BFR procedure and canceling a cell BFR procedure in a cell that includes multiple TRPs, in accordance with some embodiments. As described in connection with FIG. 7, both BFR procedures can be initiated and their performance can overlap at least in part over time. Subsequently, the cell BFR procedure can be canceled upon an opportunity to do so.

Similar to the example 700 of FIG. 7, a network 801 can configure a UE 804 to use a first TRP BFR procedure, a second TRP BFR procedure, and a cell BFR procedure in an SpCell. Upon detecting a first beam failure associated with a first TRP of the SpCell (a first trigger illustrated with a solid dark circle in FIG. 8), the UE 804 initiates the TRP BFR procedure. Upon detecting a second beam failure associated with a second TRP of the SpCell, where this second beam failure (a second trigger illustrated with a dot-filled circle in FIG. 8) triggers a beam recovery prior to the completion of the first TRP BFR procedure, the UE 804 can initiate the SpCell BFR procedure instead of the second TRP BFR procedure.

In the illustration of FIG. 8, the first TRP BFR procedure includes the UE 804 receiving a dedicated uplink grant from the network 801 in response to sending a first BFR information associated with the first TRP (e.g., sent in an enhanced MAC CE per the first TRP BFR procedure). A dedicated uplink grant is also received after the second trigger that caused the UE 804 to initiate the BFR RACH procedure. Here, the reception of this uplink grant corresponds to a successful completion of the first TRP BFR procedure (illustrated with a blank circle in FIG. 8) and can be used as an opportunity to cancel the BFR RACH procedure (or, equivalently, the SpCell BFR procedure) because second BFR information associated with the second TRP can be subsequently sent in the granted uplink resource. Accordingly, the UE 804 cancels the BFR RACH procedure and sends the second BFR information by using the granted uplink resource (e.g., the second BFR information can be sent in a second enhanced MAC CE).

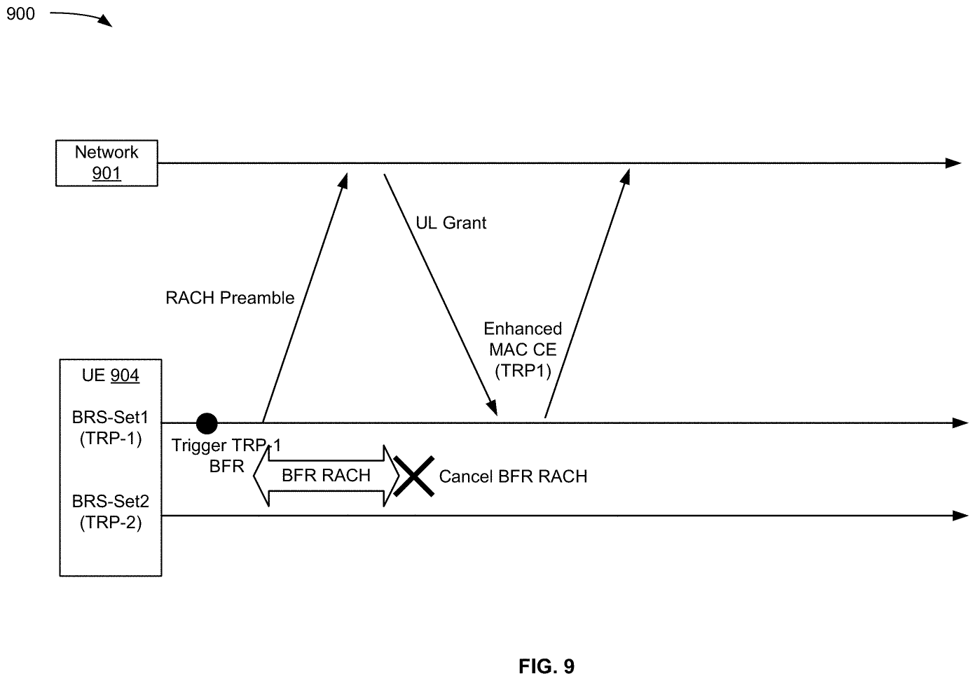

FIG. 9 illustrates an example 900 of canceling a cell BFR procedure in a cell that includes multiple TRPs, in accordance with some embodiments. As described in connection with FIG. 6, a network 901 configures the cell BFR procedure for a UE 904. In comparison, a TRP BFR procedure may not be configured. Accordingly, upon detecting a beam failure associated with a TRP (e.g., a first TRP in FIG. 9), the UE 904 initiates the cell BFR procedure (e.g., an SpCell BFR procedure in the case of an SpCell, where this procedure includes a BFR RACH procedure that causes the UE 904 to send a RACH preamble). This detection corresponds to a trigger of a BFR procedure and is illustrated in FIG. 9 with a solid dark circle. A dedicated uplink grant can be received after the first trigger (e.g., after the RACH preamble is sent). The reception of this uplink grant can be used as an opportunity to cancel the BFR RACH procedure (or, equivalently, the cell BFR procedure) because BFR information for the beam recovery (e.g., first BFR information associated with the first TRP) can be sent in the granted uplink resource. Accordingly, the UE 904 cancels the BFR RACH procedure and sends the BFR information in an enhanced MAC CE on the granted uplink resource.

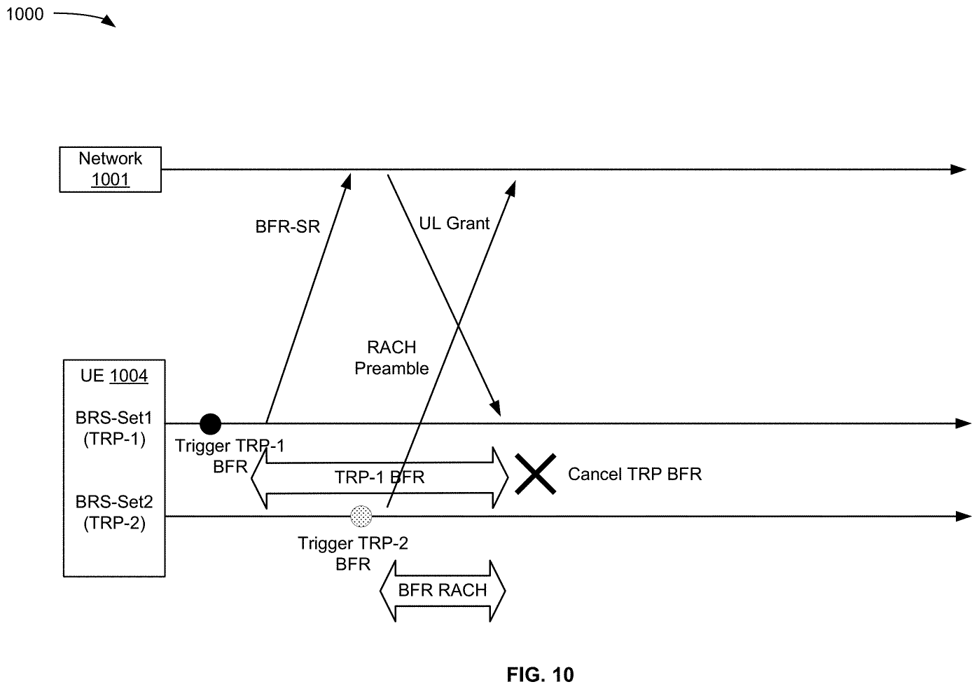

FIG. 10 illustrates an example 1000 of canceling a TRP BFR procedure and using a cell BFR procedure in a cell that includes multiple TRPs, in accordance with some embodiments. As described in connection with FIG. 7, both BFR procedures can be initiated and their performance can overlap at least in part over time. Because the cell BFR procedure can be more robust, canceling the TRP BFR procedure is possible as long as BFR information for recovering the beam failures is sent to a network 1001. As such, when both BFR procedures are ongoing, a UE 1004 can determine an opportunity to cancel the TRP BFR procedure and does so upon the opportunity being determined. Different opportunity types are possible. The example 1000 of FIG. 10 corresponds to one possible opportunity.

Similar to the example 700 of FIG. 7, the network 1001 can configure the UE 1004 to use a first TRP BFR procedure, a second TRP BFR procedure, and a cell BFR procedure in an SpCell. Upon detecting a first beam failure associated with a first TRP of the SpCell (a first trigger illustrated with a solid dark circle in FIG. 10), the UE 1004 initiates the first TRP BFR procedure. Upon detecting a second beam failure associated with a second TRP of the SpCell, where this second beam failure (a second trigger illustrated with a dot-filled circle in FIG. 10) triggers a beam recovery prior to the completion of the first TRP BFR procedure, the UE 1004 can initiate the SpCell BFR procedure instead of the second TRP BFR procedure.

In the illustration of FIG. 10, the first TRP BFR procedure includes the UE 1004 receiving a dedicated uplink grant from the network 1001 in response to sending a BSR-RS. The uplink grant is received after the second trigger (e.g., after the UE 1004 triggers the RACH procedure for the BFR and sends a RACH preamble) and before the first BFR information associated with the first TRP is sent (e.g., an enhanced MAC CE is not set per the first TRP BFR procedure, or sent in a Msg3/MsgA of the RACH procedure). Here, the SpCell BFR procedure can be used to send the first BFR information and second BFR information associated with the second TRP. This use of the SpCell BFR procedure is an opportunity to cancel the first TRP BFR procedure. Accordingly, the UE 1004 cancels the first TRP BFR procedure, and continues the processing of the SpCell BFR procedure.

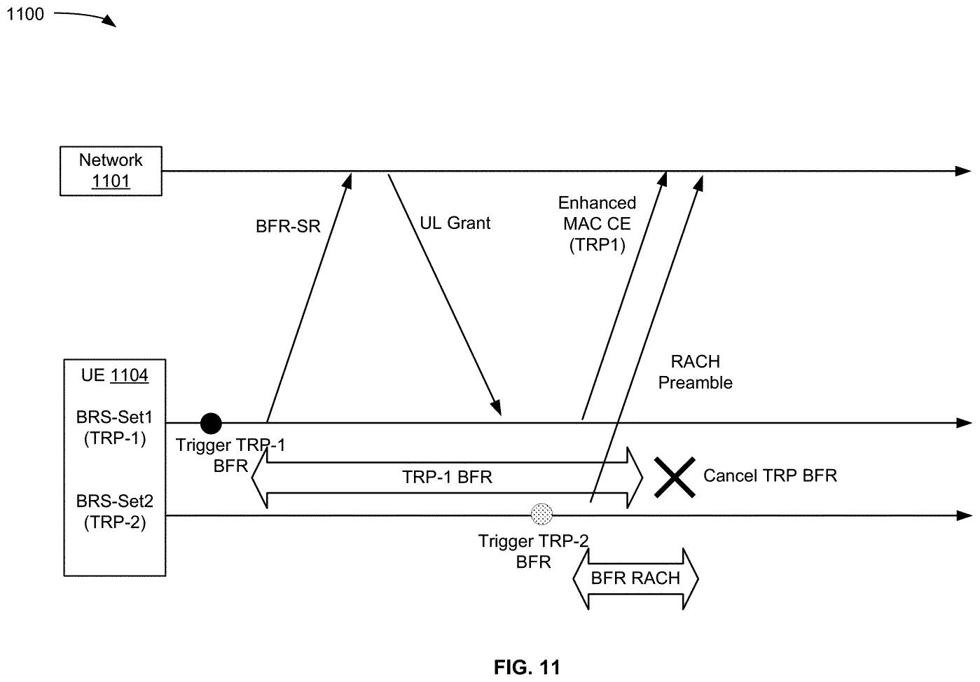

FIG. 11 illustrates another example 1100 of canceling a TRP BFR procedure and using a cell BFR procedure in a cell that includes multiple TRPs, in accordance with some embodiments. As described in connection with FIG. 10, both BFR procedures can be initiated and their performance can overlap at least in part over time. Unlike the example 1000, an enhanced BFR MAC CE is sent per the TRP BFR procedure. Nonetheless, this procedure can be canceled based on the performance of the cell BFR procedure.

Similar to the example 1000 of FIG. 10, the network 1101 can configure the UE 1104 to use a first TRP BFR procedure, a second TRP BFR procedure, and a cell BFR procedure in an SpCell. Upon detecting a first beam failure associated with a first TRP of the SpCell (a first trigger illustrated with a solid dark circle in FIG. 11), the UE 1104 initiates the first TRP BFR procedure. Upon detecting a second beam failure associated with a second TRP of the SpCell, where this second beam failure (a second trigger illustrated with a dot-filled circle in FIG. 11) triggers a beam recovery prior to the completion of the first TRP BFR procedure, the UE 1104 can initiate the SpCell BFR procedure instead of the second TRP BFR procedure.

In the illustration of FIG. 11, the first TRP BFR procedure includes the UE 1104 receiving a dedicated uplink grant from the network 1001 in response to sending a BSR-RS and, subsequently, sending an enhanced BFR MAC CE that includes the first BFR information associated with the first TRP. The second trigger occurs after the sending of this enhanced MAC CE and results in triggering the SpCell BFR procedure. This use of the SpCell BFR procedure is an opportunity to cancel the first TRP BFR procedure. Accordingly, the UE 1104 cancels the first TRP BFR procedure, and continues the processing of the SpCell BFR procedure. Here, the SpCell BFR procedure can be used to send second BFR information associated with the second TRP and, optionally, the first BFR information.

Referring back to the above figures, during the BFR RACH procedure of a cell BFR procedure, a MAC CE (referred to herein as an enhanced BFR MAC CE and further illustrated in FIGS. 14-16) can be sent in Msg3 or MsgA. The uplink grant may not be very big. Sometimes, the uplink in Msg3/MsgA is not sufficient to include the whole enhanced BFR MAC CE. Different options exist to indicate the enhanced BFR MAC CE in such situations.

A first example option can be based on also using a TRP BFR procedure. Assume that a first TRP procedure is performed and first BFR information associated with a first TRP being sent (e.g., in a first BFR MAC CE) per this procedure and prior to the Msg3/MsgA transmission of the BFR RACH procedure. In this case, the Enhanced BFR MAC CE of the BFR RACH procedure can skip the first BFR information, but optionally indicate that the first BFR information has been previously sent.

A second example option relates to using a truncated BFR MAC CE. This MAC CE can carry, depending on the amount of information, the entire or a portion of the first BFR information and/or the entire or a portion of second BFR information associated with a second TRP. Any remaining BFR information portion(s) can be sent subsequently based on a dedicated uplink grant. As such, if the first BFR information has not been sent out, when the MAC PDU assembly is being performed according the Msg3/MsgA uplink grant, the UE can indicate the truncated BFR MAC CE to indicate partial of the BFR MAC CE, and the leftover information can be sent later based on the dedicated uplink grant. In an illustration, the truncated BFR MAC CE includes the first BFR information and an LCID indicating that this BFR MAC CE is truncated. In another illustration, the truncated BFR MAC CE includes the first BFR information and a portion of the second BFR information.

A third example option involves reporting both the first BFR information and the second BFR information regardless of whether the first BFR information was delivered per the first TRP BFR procedure. In this example, if the uplink grant cannot accommodate the whole enhanced BFR MAC CE, the same approach as in the first example option or the second example option above can be used to report the BFR information.

A fourth example option relates to using a legacy BFR MAC CE rather than an enhanced BFR MAC CE if the uplink grant is insufficient for the enhanced BFR MAC CE. Here, the legacy BFR MAC CE may be smaller in size than the enhanced BFR MAC CE and, therefore, may not include the entirety of the first BFR information and the second BFR information. In this case, a priority scheme can be used where either the first BFR information or the second BFR information is selected and included in the legacy BFR MAC CE. The priority can be indicated via an RRC configuration or can be predefined in logic of the UE and can specify which one of the two TRPs should have a higher priority. The BFR information corresponding to the higher priority TRP is then selected.

FIG. 12 illustrates an example 1200 of using multiple TRP BFR procedures in a cell that includes multiple TRPs, in accordance with some embodiments. The cell can be an SCell rather than an SpCell. In this case, the TRP BFR procedures are used rather than an SpCell BFR procedure.

Similar to the example 500 of FIG. 5, a network 1201 can configure a UE 1204 to use a first TRP BFR procedure and a second TRP BFR procedure. Upon detecting a first beam failure associated with a first TRP of the SCell (a first trigger illustrated with a solid dark circle in FIG. 12), the UE 1204 initiates the first TRP BFR procedure. Prior to the successful completion of the first TRP BFR procedure, a second beam failure associated with a second TRP of the SCell is detected. This second beam failure can be a second trigger for beam recovery (illustrated with a dot-filled circle in FIG. 12). As such, the UE 1204 can initiate the second TRP BFR procedure. In this example 1200, the UE 1204 can initiate and maintain the first TRP BFR procedure and the second TRP BFR procedure separately.

FIG. 13 illustrates another example 1300 of using a TRP BFR procedure and canceling another TRP BFR procedure in a cell that includes multiple TRPs, in accordance with some embodiments. Whereas example 1200 of FIG. 12 illustrates the separate use of two TRP BFR procedures, the example 1300 describes a related use of such procedures.

Similar to the example 1200, a network 1301 can configure a UE 1304 to use a first TRP BFR procedure and a second TRP BFR procedure. Upon detecting a first beam failure associated with a first TRP of the SCell (a first trigger illustrated with a solid dark circle in FIG. 12), the UE 1304 initiates the first TRP BFR procedure. Prior to the successful completion of the first TRP BFR procedure, a second beam failure associated with a second TRP of the SCell is detected. This second beam failure can be a second trigger for beam recovery (illustrated with a dot-filled circle in FIG. 13). As such, the UE 1304 can initiate the second TRP BFR procedure.

Here, upon initiating the second TRP BFR procedure, the UE 1304 can cancel the first TRP BFR procedure and proceed with the second TRP BFR procedure until a successful completion (illustrated in FIG. 13 with a blank circle). The successful completion can be that of the first TRP BFR only, the second TRP BFR only, the first TRP BFR procedure and the second TRP BFR procedure jointly depending at least in part on the BFR information that is sent to the network. If the first BFR information associated with the first TRP has not been sent yet (e.g., the canceling of the first TRP BFR procedure occurs first), different options exist to send this information. In the example 1300, the first BFR information can be sent along with second BFR information associated with the second TRP in, for instance, an enhanced BFR MAC CE sent per the second TRP BFR procedure. Alternatively, the first BFR MAC CE can be sent following an uplink grant subsequent to the enhanced BFR MAC CE of the second TRP BFR procedure (in which case, this MAC CE may carry only the second BFR information). If the first BFR information has already been sent yet (e.g., the canceling of the first TRP BFR procedure occurs after this transmission), this information can be re-sent using or the second TRP BFR procedure and can indicate that the first BFR information has already been sent. Additionally, and as indicated with the dotted arrow, the second TRP BFR procedure may be modified, where the UE 1304 can decide whether to trigger the BFR-SR of the second TRP BFR procedure based on whether the BFR-SR of the first TRP BFR procedure is transmitted or not. For instance, if the first TRP BFR procedure is sent, the UE 1304 may not send the BFR-SR of the second TRP BFR procedure.

Referring back to the SCell examples, BFR information associated with a TRP of the SCell is sent to a network. An enhanced BFR MAC CE can be used for this purpose. The means to carry the BFR information (e.g., whether the enhanced BFR MAC CE is to be sent per an uplink grant, per a TRP BFR procedure, or per a cell BFR procedure) can depend on a number of factors. For example, if there is an available uplink grant, the UE can include the enhanced BFR MAC CE in it. However, if an uplink grant is not available, the UE can rely on the TRP BFR procedure or the cell BFR procedure (which can be an SpCell BFR procedure). In particular, if BFR-SR is configured, the UE can trigger the BFR-SR transmission, and send the enhanced BFR MAC CE via the following uplink grant. Otherwise, the UE can trigger the SpCell BFR RACH to send the enhanced BFR MAC CE.

FIG. 14 illustrates an example of an enhanced BFR MAC CE 1400 usable to send BFR information to a network, in accordance with some embodiments. As described herein above, a cell includes multiple TRPs. A first beam failure associated with a first TRP of the cell may occur. The enhanced BFR MAC CE 1400 can be sent to indicate first BFR information associated with the first TRP. This enhanced BFR MAC CE 1400 can also indicate information associated with a second TRP of the cell. For instance, if a second BFR beam failure associated with the second TRP occurs, the enhanced BFR MAC CE 1400 can also indicate second BFR information associated with the second TRP. Alternatively, if no such second beam failure occurs, the enhanced BFR MAC CE 1400 can indicate that no beam failure is detected in association with the second TRP.

To support the information indications about the different TRPs, the enhanced BFR MAC CE 1400 includes, in a first example, a first field associated with the first TRP and a second field associated with the second TRP. The first field indicates the first beam failure. In comparison, the second field indicates whether a second beam failure associated with the second TRP is detected. Of course, if the cell includes more than two TRPs, additional fields can also be included in the enhanced BFR MAC CE 1400.

In the particular illustration of FIG. 14, the enhanced BFR MAC CE 1400 may be used to indicate beam failure information (e.g., failed beam(s), BFR request, etc.), and may also be used to indicate candidate beams (e.g., NBI). Generally, a MAC CE is a bit string that is byte aligned (e.g., multiple of 8 bits) in length. In FIG. 14, bit strings are represented by tables in which the most significant bit is the leftmost bit of the first line of the table, the least significant bit is the rightmost bit on the last line of the table, and more generally the bit string is to be read from left to right and then in the reading order of the lines. The bit order of each parameter field within a MAC PDU is represented with the first and most significant bit in the leftmost bit and the last and least significant bit in the rightmost bit. The enhanced BFR MAC CE 1400 may, but need not, be a truncated BFR MAC CE.

Furthermore, the enhanced BFR MAC CE 1400 can be identified by a MAC sub-header with LCD as specified by table 6.2.1-2 in 3GPP TS38.321 and can have a variable size. The enhanced BFR MAC CE 1400 includes a bitmap and in ascending order based on the ServCellindex, BFR information (e.g., octets containing candidate beam availability indication (AC) for SCells indicated in the bitmap). A single octet bitmap can be used when the highest ServCellindex of the MAC entity's cell for which beam failure is detected is less than eight, otherwise four octets can be used. In some implementations, a MAC PDU contains at most one enhanced BFR MAC CE.

For truncated BFR MAC CE, a single octet bitmap can be used when the highest ServCellindex of the MAC entity's cell for which beam failure is detected is less than eight, or when beam failure is detected for an SpCell (as specified in 3GPP TS38.321) and the SpCell is to be indicated in a Truncated BFR MAC CE, and the UL-SCH resources available for transmission cannot accommodate the truncated BFR MAC CE with the four octets bitmap plus its subheader as a result of LCP. Otherwise, four octets can be used. The fields in the non-truncated or truncated BFR MAC CE are as follows.

The Cᵢ (where “i” is a positive integer field for (non-truncated) BFR MAC CEs) indicates BFD and the presence of an octet containing the AC field for the cell with ServCellindex “i.” The Cᵢ field set to 1 indicates that beam failure is detected and the octet containing the AC field is present for the cell with ServCellindex “i.” The Cᵢ field set to 0 indicates that the beam failure is not detected and the octet containing the AC field is not present for the cell with ServCellindex “i.” The octets containing the AC field are present in ascending order based on the ServCellindex.

The Cᵢ field for truncated BFR MAC CEs indicates beam failure detection for the cell with ServCellindex “i.” The Cᵢ field set to 1 indicates that beam failure is detected and the octet containing the AC field for the cell with ServCellindex “i” may be present. The Cᵢ field set to 0 indicates that the beam failure is not detected and the octet containing the AC field is not present for the cell with ServCellindex “i.” The octets containing the AC field, if present, are included in ascending order based on the ServCellindex. The number of octets containing the AC field included is maximized, while not exceeding the available grant size. The number of the octets containing the AC field in the truncated BFR MAC CE can be zero.

The SP field indicates beam failure detection for an SpCell of this MAC entity. The SP field is set to 1 to indicate that beam failure is detected for SpCell only when BFR MAC CE or Truncated BFR MAC CE is to be included into a MAC PDU as part of random access procedure; otherwise, it is set to 0.

The AC field indicates the presence of the Candidate RS ID field in this octet. If at least one of the SSBs with SS-RSRP above rsrp-ThresholdBFR amongst the SSBs in candidateBeamRSSCellList or the CSI-RSs with CSI-RSRP above rsrp-ThresholdBFR amongst the CSI-RSs in candidateBeamRSSCellList is available, the AC field is set to 1; otherwise, it is set to 0. If the AC field set to 1, the Candidate RS ID field is present. If the AC field is set to 0, R bits are present instead. The reserved bit field (R) is set to 0.

The Candidate RS ID field is set to the index of an SSB with SS-RSRP above rsrp-ThresholdBFR amongst the SSBs in candidateBeamRSSCellList or to the index of a CSI-RS with CSI-RSRP above rsrp-ThresholdBFR amongst the CSI-RSs in candidateBeamRSSCellList. In some examples, the index of an SSB or CSI-RS is the index of an entry in candidateBeamRSSCellList corresponding to that SSB or CSI-RS. In one example, index 0 corresponds to a first entry in candidateBeamRSSCellList, index 1 corresponds to second entry in this list, and so forth. The length of this field can be 6 bits.

As also illustrated in FIG. 14, the enhanced BFR MAC CE 1400 (non-truncated or truncated) can include a Ti field, one for TRP and/or BFR-RS set (T1 and T2 are shown in FIG. 14). The Ti field can be an octet. When set to 0, the Ti field indicates that the corresponding TRP has no beam failure problem. When set to 1, the Ti field indicates that the corresponding TRP has a beam failure problem. For each serving cell (e.g., an SpCell or an SCell), the reported TRP number can be set to 0, or 1 or 2.

For a truncated enhanced BFR MAC CE, if one cell's information (e.g., associated with two TRPs) cannot be accommodated, the UE can indicate the problematic TRP information, the information of one TRP, or none of it. For instance, the truncated enhanced BFR MAC CE includes a first field associated with the first TRP and a second field that includes BFR information associated with the first beam failure. Or the truncated enhanced BFR MAC CE includes a first field associated with the first TRP and a second field that excludes BFR information associated with the first beam failure.

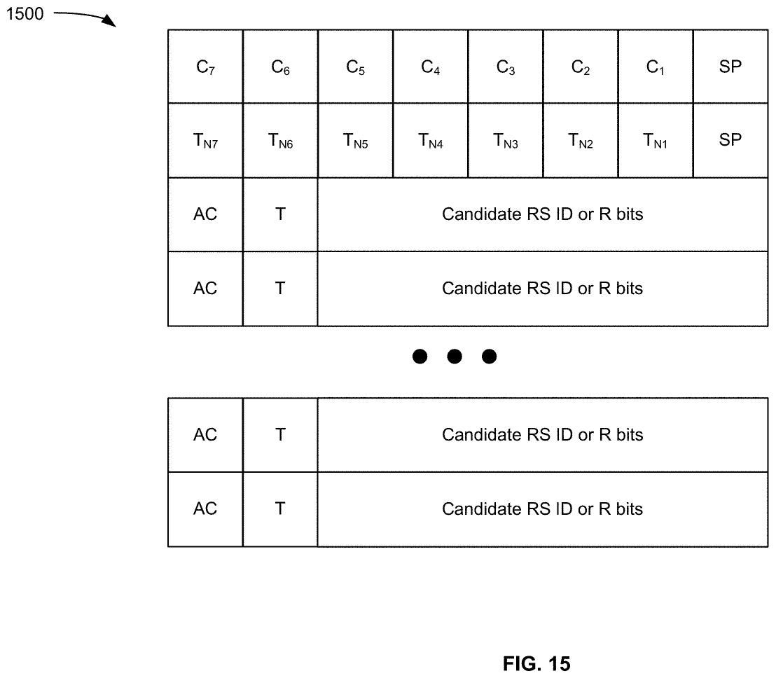

FIG. 15 illustrates another example of an enhanced BFR MAC CE 1500 usable to send BFR information to a network, in accordance with some embodiments. As illustrated, the enhanced BFR MAC CE 1500 includes Cᵢ fields, an SP field, AC fields, and Candidate RS ID or R bits fields, similar to the enhanced BFR MAC CE 1400 of FIG. 14. The enhanced BFR MAC CE 1500 also includes a first field indicating whether a plurality of beam failures are detected for the cell, and a second field indicating a TRP index of the first TRP.

In the illustration of FIG. 15, the first field is shown as a T_{Ni} field per cell (or corresponding to each Ci field). The T_{Ni} field can be an octet whether 1 or 2 bytes are reported for the corresponding cell. For instance, when set to 0, the T_{Ni} field indicates that 1 byte is included for one TRP of the cell. When set to 1, the T_{Ni} field indicates that 2 bytes are included, one for each of the two TRPs of the cell.

In the illustration of FIG. 15, the second field is shown as a T field. In particular, for each BFR information of a TRP, T bit is used to indicate the TRP index. For instance, when set to 0, the T field indicates the first TRP. When set to 1, the T field indicates the second TRP.

Here also, the enhanced BFR MAC CE 1500 can be a truncated BFR MAC CE. For the truncated enhanced MAC CE, the UE can indicate all the problematic information in the first two octets. It may be also possible to include partial TRP information of one cell.

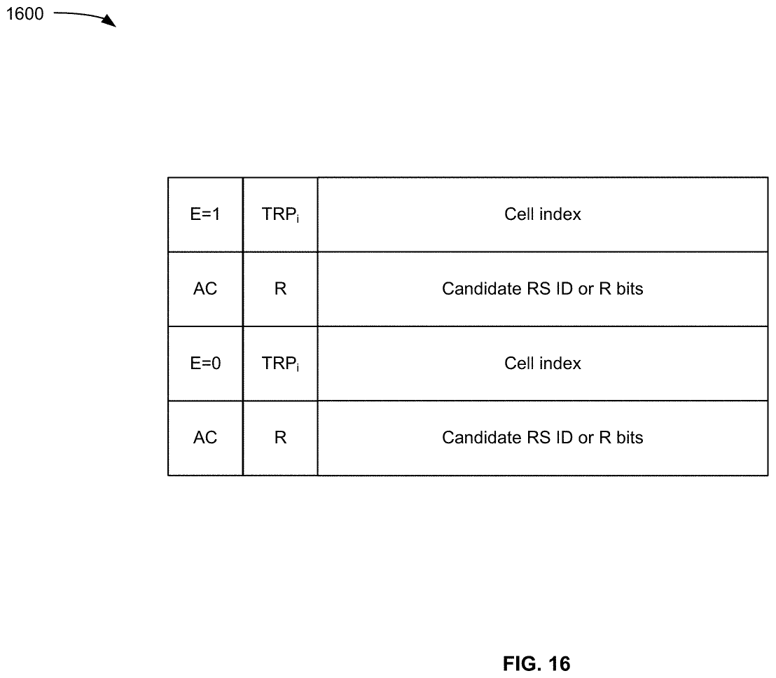

FIG. 16 illustrates yet another example of an enhanced BFR MAC CE 1600 usable to send BFR information to a network, in accordance with some embodiments. The enhanced BFR MAC CE 1600 can group the information of one cell (e.g., of the different TRPs of the cell) together and may not include information about other cells. As illustrated, the enhanced BFR MAC CE 1600 includes AC fields similar to the enhanced BFR MAC CE 1400 of FIG. 14. It also includes R fields, similar to legacy BFR MAC CE. In addition, the enhanced BFR MAC CE 1600 includes a first field indicating a start of BFR information for beam recovery in the cell and a second field indicating an end of the BFR information.

In the illustration of FIG. 16, the first field is shown as an E bit set to 1. The second field is shown as also an E bit, but this E bit is set to 0. Next to each E bit, a TRPi field is included and indicates the TRP of the cell. Also a cell index field is included next to each TRPi field to indicate the index of the cell.

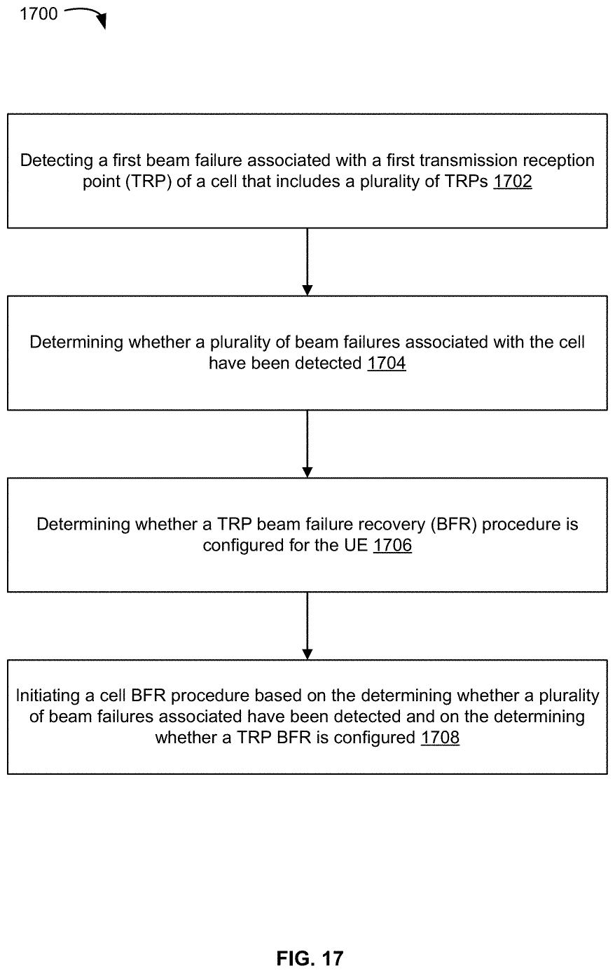

FIG. 17 illustrates an example of an operational flow/algorithmic structure 1700 for beam failure recovery in a cell that includes multiple TRPs, in accordance with some embodiments. The operation flow/algorithmic structure 1700 may be performed or implemented by a UE, such as the UE 104, 2100, or components thereof; for example, processors 2104.

The operation flow/algorithmic structure 1700 may include, at 1702, detecting a first beam failure associated with a first TRP of a cell that includes a plurality of TRPs. In some embodiments, the UE is configured to perform a BFD procedure per TRP of the cell. The cell may be an SpCell that includes at least two TRPs.

The operation flow/algorithmic structure 1700 may also include, at 1704, determining whether a plurality of beam failures associated with the cell have been detected. In some embodiments, upon performing the TRP BFD procedures, the UE may detect only the first beam failure or may detect a second beam failure associated with a second TRP of the cell. Additionally or alternatively, upon detecting the first beam failure, the UE may determine that an ongoing BFR procedure (e.g., a TRP or cell BFR procedure) is being performed and corresponds to the second beam failure.

The operation flow/algorithmic structure 1700 may also include, at 1706, determining whether a TRP BFR procedure is configured for the UE. In some embodiments, a network can configure the UE to perform one or more BFR procedures including one or more TRP BFR procedures and/or a cell BFR procedure (e.g., an SpCell BFR procedure). The TRP BFR procedure can be a first TRP BFR procedure associated with the first TRP and can be configured based on RRC signaling that indicates a first BRS set associated with the first TRP. Similarly, a second BFR procedure can be configured and based on RRC signaling that indicates a second BRS set associated with the second TRP. If no such configuration information is received, the UE can determine that no TRP BFR procedure is configured.

The operation flow/algorithmic structure 1700 may also include, at 1708, initiating a cell BFR procedure based on the determining whether a plurality of beam failures associated have been detected and on the determining whether a TRP BFR is configured. In some embodiments, only the first beam failure is detected. In this case, the cell BFR procedure (e.g., an SpCell BFR procedure) is initiated upon a determination that the first TRP BFR procedure is not configured for the UE. In other embodiments, the first beam failure and the second beam failure are detected. The second TRP BFR procedure has already been initiated and is ongoing when the second beam failure is detected. Accordingly, the UE can initiate the cell BFR procedure instead of the first TRP BFR procedure. Additionally, the UE may cancel the ongoing second TRP BFR procedure.

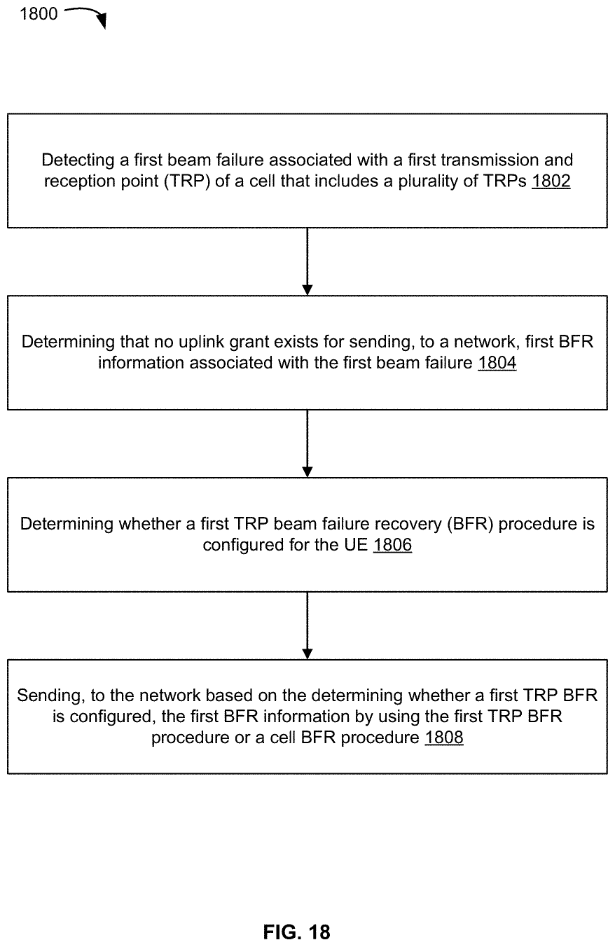

FIG. 18 illustrates an example of an operational flow/algorithmic structure 1800 for canceling a cell BFR procedure, in accordance with some embodiments. The operation flow/algorithmic structure 1800 may be performed or implemented by a UE, such as the UE 104, 2100, or components thereof, for example, processors 2104.

The operation flow/algorithmic structure 1800 may include, at 1802, detecting a first beam failure associated with a first TRP of a cell that includes a plurality of TRPs. In some embodiments, UE is configured to perform a BFD procedure per TRP of the cell. The cell may be an SCell that includes at least two TRPs.

The operation flow/algorithmic structure 1800 may also include, at 1804, determining that no uplink grant exists for sending, to a network, first BFR information associated with the first beam failure. In some embodiments, no resource has been scheduled on PUCCH or PUSCH that would allow the UE to send a BFR MAC CE that includes the first BFR information.

The operation flow/algorithmic structure 1800 may also include, at 1806, determining whether a first TRP BFR procedure is configured for the UE. In some embodiments, the network can configure the UE to perform one or more BFR procedures including one or more TRP BFR procedures and/or a cell BFR procedure (e.g., an SpCell BFR procedure). The TRP BFR procedure can be the first TRP BFR procedure associated with the first TRP and can be configured based on RRC signaling that indicates a first BRS set associated with the first TRP. Similarly, a second BFR procedure can be configured and based on RRC signaling that indicates a second BRS set associated with the second TRP. If no such configuration information is received, the UE can determine that no TRP BFR procedure is configured.

The operation flow/algorithmic structure 1800 may also include, at 1808, sending, to the network based on the determining whether a first TRP BFR is configured, the first BFR information by using the first TRP BFR procedure or a cell BFR procedure. In some embodiments, if the first TRP BFR procedure is configured, the UE sends the first BFR information in a BFR MAC CE based a dedicated uplink grant determined per the first TRP BFR procedure. Otherwise, the UE performs the cell BFR procedure, which can be similar to an SpCell BFR procedure.

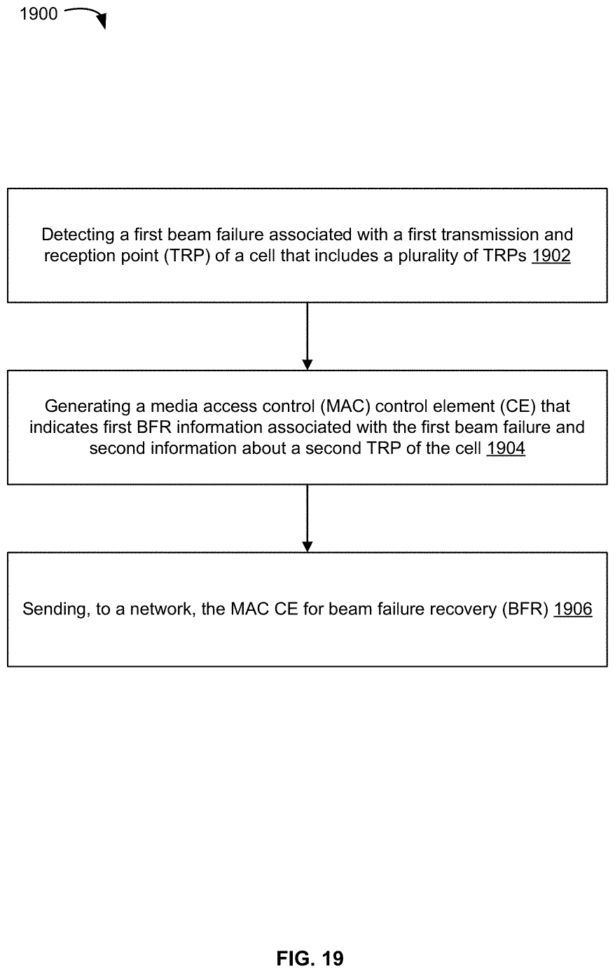

FIG. 19 illustrates an example of an operational flow/algorithmic structure 1900 for initiating a cell BFR procedure, in accordance with some embodiments. The operation flow/algorithmic structure 1900 may be performed or implemented by a UE, such as the UE 104, 2100, or components thereof, for example, processors 2104.

The operation flow/algorithmic structure 1900 may include, at 1902, detecting a first beam failure associated with a first TRP of a cell that includes a plurality of TRPs. In some embodiments, UE is configured to perform a BFD procedure per TRP of the cell. The cell may be an SpCell or an SCell, where any of such cells includes at least two TRPs.

The operation flow/algorithmic structure 1900 may also include, at 1904, generating a MAC CE that indicates first BFR information associated with the first beam failure and second information about a second TRP of the cell. In some embodiments, the MAC CE is an enhanced BFR MAC CE that may be non-truncated or truncated. The enhanced BFR MAC CE can include the fields described in any of FIGS. 14-16 to indicate the first BFR information and the second information.

The operation flow/algorithmic structure 1900 may also include, at 1906, sending, to a network, the MAC CE for BFR. In some embodiments, the MAC CE is sent based on an uplink grant that may be available independent of a BFR procedure. In some other embodiments, the MAC CE is sent based on an uplink grant that may be a part of a TRP BFR procedure or that may be scheduled based on a successful completion of the TRP BFR procedure. In yet other embodiments, the MAC CE is sent based on a Msg3/MsgA of a cell BFR procedure or on an uplink that may be scheduled based on a successful completion of the cell BFR procedure.

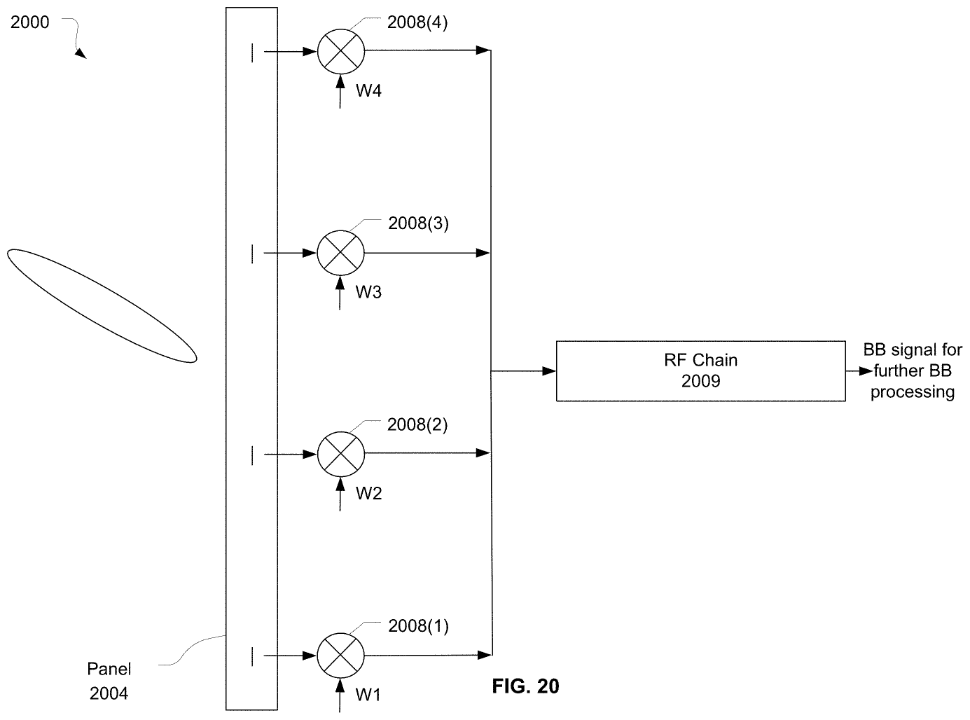

FIG. 20 illustrates receive components 2000 of the UE 104, in accordance with some embodiments. The receive components 2000 may include an antenna panel 2004 that includes a number of antenna elements. The panel 2004 is shown with four antenna elements, but other embodiments may include other numbers. Multiple antenna panels may also be included.

The antenna panel 2004 may be coupled to analog beamforming (BF) components that include a number of phase shifters 2008(1)-2008(4). The phase shifters 2008(1)-2008(4) may be coupled with a radio-frequency (RF) chain 2009. The RF chain 2009 may amplify a receive analog RF signal, down-convert the RF signal to baseband, and convert the analog baseband signal to a digital baseband signal that may be provided to a baseband processor for further processing.

In various embodiments, control circuitry, which may reside in a baseband processor, may provide BF weights (for example W1-W4), which may represent phase shift values to the phase shifters 2008(1)-2008(4) to provide a receive beam at the antenna panel 2004. These BF weights may be determined based on the channel-based beamforming.

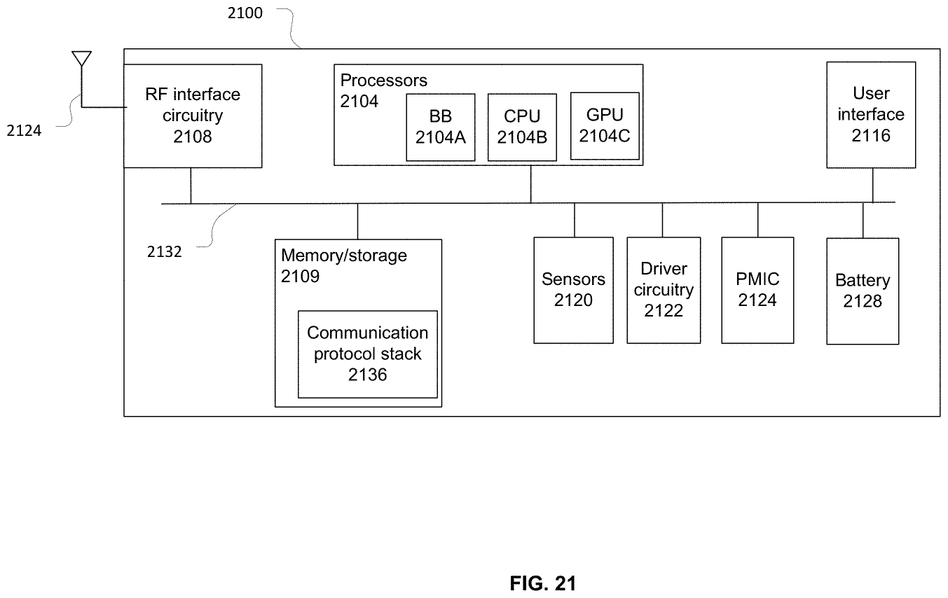

FIG. 21 illustrates a UE 2100, in accordance with some embodiments. The UE 2100 may be similar to and substantially interchangeable with UE 104 of FIG. 1.

Similar to that described above with respect to UE 104, the UE 2100 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, and actuators), video surveillance/monitoring devices (for example, cameras and video cameras), wearable devices, or relaxed-IoT devices. In some embodiments, the UE may be a reduced capacity UE or NR-Light UE.

The UE 2100 may include processors 2104, RF interface circuitry 2108, memory/storage 2109, user interface 2116, sensors 2120, driver circuitry 2122, power management integrated circuit (PMIC) 2124, and battery 2128. The components of the UE 2100 may be implemented as integrated circuits (ICs), portions thereof, discrete electronic devices, or other modules, such as logic, hardware, software, firmware, or a combination thereof. The block diagram of FIG. 21 is intended to show a high-level view of some of the components of the UE 2100. However, some of the components shown may be omitted, additional components may be present, and different arrangements of the components shown may occur in other implementations.

The components of the UE 2100 may be coupled with various other components over one or more interconnects 2132 which may represent any type of interface, input/output, bus (local, system, or expansion), transmission line, trace, optical connection, etc. that allows various circuit components (on common or different chips or chipsets) to interact with one another.

The processors 2104 may include processor circuitry, such as baseband processor circuitry (BB) 2104A, central processor unit circuitry (CPU) 2104B, and graphics processor unit circuitry (GPU) 2104C. The processors 2104 may include any type of circuitry or processor circuitry that executes or otherwise operates computer-executable instructions, such as program code, software modules, or functional processes from memory/storage 2109 to cause the UE 2100 to perform operations as described herein.

In some embodiments, the baseband processor circuitry 2104A may access a communication protocol stack 2136 in the memory/storage 2109 to communicate over a 3GPP compatible network. In general, the baseband processor circuitry 2104A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 2108.

The baseband processor circuitry 2104A may generate or process baseband signals or waveforms that carry information in 3GPP-compatible networks. In some embodiments, the waveforms for NR may be based on cyclic prefix OFDM (CP-OFDM) in the uplink or downlink and discrete Fourier transform spread OFDM (DFT-S-OFDM) in the uplink.

The baseband processor circuitry 2104A may also access group information 2124 from memory/storage 2109 to determine search space groups in which a number of repetitions of a PDCCH may be transmitted.

The memory/storage 2112 may include any type of volatile or non-volatile memory that may be distributed throughout the UE 2100. In some embodiments, some of the memory/storage 2112 may be located on the processors 2104 themselves (for example, L1 and L2 cache), while other memory/storage 2112 is external to the processors 2104 but accessible thereto via a memory interface. The memory/storage 2112 may include any suitable volatile or non-volatile memory, such as, but not limited to, dynamic random-access memory (DRAM), static random-access memory (SRAM), erasable programmable read-only memory (EPROM), electrically erasable programmable read-only memory (EEPROM), Flash memory, solid-state memory, or any other type of memory device technology.

The RF interface circuitry 2108 may include transceiver circuitry and a radio frequency front module (RFEM) that allows the UE 2100 to communicate with other devices over a radio access network. The RF interface circuitry 2108 may include various elements arranged in transmit or receive paths. These elements may include switches, mixers, amplifiers, filters, synthesizer circuitry, control circuitry, etc.

In the receive path, the RFEM may receive a radiated signal from an air interface via an antenna 2124 and proceed to filter and amplify (with a low-noise amplifier) the signal. The signal may be provided to a receiver of the transceiver that down-converts the RF signal into a baseband signal that is provided to the baseband processor of the processors 2104.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 2124.

In various embodiments, the RF interface circuitry 2108 may be configured to transmit/receive signals in a manner compatible with NR access technologies.

The antenna 2124 may include a number of antenna elements that each convert electrical signals into radio waves to travel through the air and to convert received radio waves into electrical signals. The antenna elements may be arranged into one or more antenna panels. The antenna 2124 may have antenna panels that are omnidirectional, directional, or a combination thereof to enable beamforming and multiple input multiple output communications. The antenna 2124 may include micro-strip antennas, printed antennas that are fabricated on the surface of one or more printed circuit boards, patch antennas, phased array antennas, etc. The antenna 2124 may have one or more panels designed for specific frequency bands including bands in FR1 or FR2.

The user interface circuitry 2116 includes various input/output (I/O) devices designed to enable user interaction with the UE 2100. The user interface 2116 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators, such as light emitting diodes (LEDs)) and multi-character visual outputs, or more complex outputs, such as display devices or touchscreens (for example, liquid crystal displays (LCDs), LED displays, quantum dot displays, projectors, etc.), with the output of characters, graphics, multimedia objects, and the like being generated or produced from the operation of the UE 2100.

The sensors 2120 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example, cameras or lens-less apertures); light detection and ranging sensors; proximity sensors (for example, infrared radiation detector and the like); depth sensors; ambient light sensors; ultrasonic transceivers; microphones or other like audio capture devices; etc.

The driver circuitry 2122 may include software and hardware elements that operate to control particular devices that are embedded in the UE 2100, attached to the UE 2100, or otherwise communicatively coupled with the UE 2100. The driver circuitry 2122 may include individual drivers allowing other components to interact with or control various input/output (I/O) devices that may be present within or connected to the UE 2100. For example, driver circuitry 2122 may include a display driver to control and allow access to a display device, a touchscreen driver to control and allow access to a touchscreen interface, sensor drivers to obtain sensor readings of sensor circuitry 2120 and control and allow access to sensor circuitry 2120, drivers to obtain actuator positions of electro-mechanic components or control and allow access to the electro-mechanic components, a camera driver to control and allow access to an embedded image capture device, or audio drivers to control and allow access to one or more audio devices.

The PMIC 2124 may manage power provided to various components of the UE 2100. In particular, with respect to the processors 2104, the PMIC 2124 may control power-source selection, voltage scaling, battery charging, or DC-to-DC conversion.

In some embodiments, the PMIC 2124 may control, or otherwise be part of, various power saving mechanisms of the UE 2100. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 2100 may power down for brief intervals of time and thus, save power. If there is no data traffic activity for an extended period of time, then the UE 2100 may transition off to an RRC_Idle state, where it disconnects from the network and does not perform operations, such as channel quality feedback, handover, etc. The UE 2100 goes into a very low power state, and it performs paging where again it periodically wakes up to listen to the network and then powers down again. The UE 2100 may not receive data in this state; in order to receive data, it must transition back to RRC Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay, and it is assumed the delay is acceptable.

A battery 2128 may power the UE 2100, although in some examples the UE 2100 may be mounted deployed in a fixed location and may have a power supply coupled to an electrical grid. The battery 2128 may be a lithium-ion battery, a metal-air battery, such as a zinc-air battery, an aluminum-air battery, a lithium-air battery, and the like. In some implementations, such as in vehicle-based applications, the battery 2128 may be a typical lead-acid automotive battery.

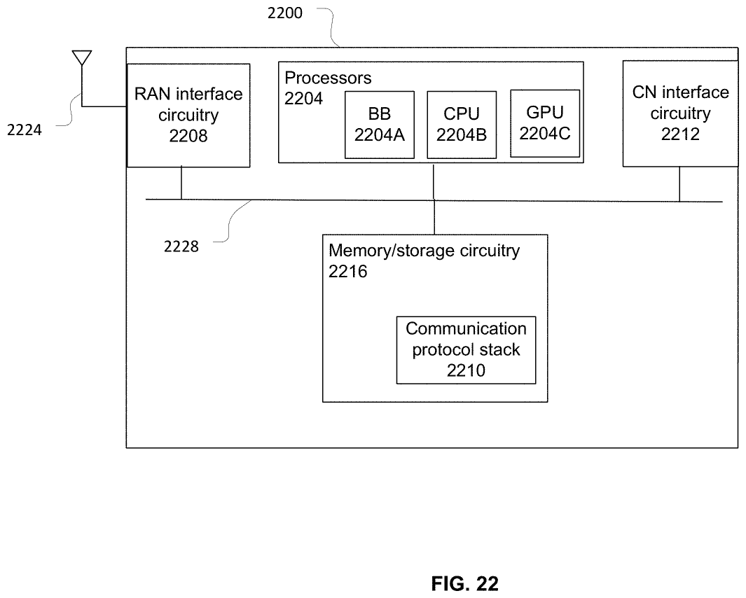

FIG. 22 illustrates a gNB 2200, in accordance with some embodiments. The gNB node 2200 may be similar to and substantially interchangeable with gNB 108 and/or components thereof can be included in a TRP.

The gNB 2200 may include processors 2204, RF interface circuitry 2208, core network (CN) interface circuitry 2212, and memory/storage circuitry 2216.

The components of the gNB 2200 may be coupled with various other components over one or more interconnects 2228.

The processors 2204, RF interface circuitry 2208, memory/storage circuitry 2216 (including communication protocol stack 2210), antenna 2224, and interconnects 2228 may be similar to like-named elements shown and described with respect to FIGS. 20 and 21.

The CN interface circuitry 2212 may provide connectivity to a core network, for example, a 5^{th} Generation Core network (5GC) using a 5GC-compatible network interface protocol, such as carrier Ethernet protocols or some other suitable protocol. Network connectivity may be provided to/from the gNB 2200 via a fiber optic or wireless backhaul. The CN interface circuitry 2212 may include one or more dedicated processors or FPGAs to communicate using one or more of the aforementioned protocols. In some implementations, the CN interface circuitry 2212 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry, as described above in connection with one or more of the preceding figures, may be configured to operate, in accordance with one or more of the examples set forth below. For another example, circuitry associated with a UE, base station, network element, etc., as described above in connection with one or more of the preceding figures, may be configured to operate in accordance with one or more of the examples set forth below in the example section.

### EXAMPLES

In the following sections, further exemplary embodiments are provided.

Example 1 includes a method. The method is implemented by a user equipment (UE). The method comprises: detecting a first beam failure associated with a first transmission and reception point (TRP) of a cell that includes a plurality of TRPs; determining whether a plurality of beam failures associated with the cell have been detected; determining whether a TRP beam failure recovery (BFR) procedure is configured for the UE; and initiating a cell BFR procedure based on the determining whether a plurality of beam failures associated have been detected and on the determining whether a TRP BFR is configured.

Example 2 includes a method of example 1, wherein the cell is a special cell (SpCell) that includes a primary cell (PCell) or a primary secondary cell group cell (PSCell), and wherein the cell BFR procedure is performed upon determining that a plurality of beam failures are detected and upon determining that the TRP BFR procedure is configured for the UE and has been initiated in association with a second TRP but has not been completed yet.

Example 3 includes a method of any preceding example 1-2, wherein the TRP BFR procedure is configured for the UE based on configuration information, wherein the configuration information includes BFR special request (BFR-SR) resource on a physical uplink control channel (PUCCH).

Example 4 includes a method of example 1, wherein the cell is a special cell (SpCell) that includes a primary cell (PCell) or a primary secondary cell group cell (PSCell), and wherein the cell BFR procedure is performed upon determining that only one beam failure is detected and determining that no TRP BFR procedure is configured for the UE.

Example 5 includes a method of example 1, wherein the cell is a special cell (SpCell) that includes a primary cell (PCell) or a primary secondary cell group cell (PSCell), and wherein the cell BFR procedure is performed upon determining that a second beam failure associated with a second TRP of the cell is detected and upon determining that the TRP BFR procedure is configured for the UE based on configuration information associated with the second TRP and not the first TRP.

Example 6 includes a method of any preceding example 1-5, further comprising: canceling the cell BFR procedure.

Example 7 includes a method of any preceding example 1-5, further comprising: determining, after the cell BFR procedure is initiated, an opportunity to send first BFR information associated with the first beam failure to a network; and canceling, based on the opportunity, the cell BFR procedure.

Example 8 includes a method of example 7, further comprising: initiating the TRP BFR procedure for a second beam failure associated with a second TRP of the cell; receiving an uplink grant based on the TRP BFR procedure; and sending, to the network based on the uplink grant, a media access control (MAC) control element (CE), wherein the opportunity includes the sending of the MAC CE.

Example 9 includes a method of example 8, wherein the uplink grant is received after the cell BFR procedure is initiated and before the MAC CE is sent, wherein the MAC CE includes the first BFR information and second BFR information associated with the second beam failure.

Example 10 includes a method of example 8, wherein the uplink grant is received after the cell BFR procedure is initiated and after the MAC CE is sent, wherein the MAC CE includes second BFR information associated with the second beam failure, and wherein the method further comprises: sending another MAC CE that includes the first BFR information.

Example 11 includes a method of example 7, further comprising: receiving, after the cell BFR procedure is initiated, an uplink grant; and sending, to the network based on the uplink grant, a media access control (MAC) control element (CE) that includes the first BFR information, wherein the opportunity includes the sending of the MAC CE.

Example 12 includes a method of any preceding example 1-5, further comprising: prior to initiating the cell BFR procedure, initiating the TRP BFR procedure for a second beam failure associated with a second TRP of the cell; and canceling the TRP BFR procedure based on the initiating of the cell BFR procedure.

Example 13 includes a method of example 12, wherein the TRP BFR procedure includes receiving an uplink grant and sending, based on the uplink grant, BFR information associated with the first beam failure to a network, and wherein the TRP BFR procedure is canceled after the cell BFR procedure is initiated and before the BFR information is sent.

Example 14 includes a method of example 12, wherein the TRP BFR procedure includes receiving an uplink grant and sending, based on the uplink grant, BFR information associated with the first beam failure to a network, and wherein the TRP BFR procedure is canceled after the cell BFR procedure is initiated and after the BFR information is sent.

Example 15 includes a method of any preceding example 1-14, further comprising: prior to initiating the cell BFR procedure, initiating the TRP BFR procedure for a second beam failure associated with a second TRP of the cell; sending, based on the TRP BFR procedure, second BFR information associated with the second beam failure to a network; and sending, based on the cell BFR procedure, first BFR information associated with the first beam failure to the network.

Example 16 includes a method of example 15, wherein the first BFR information is sent in a message of the cell BFR procedure, and wherein the message indicates that the second BFR information has been previously sent.

Example 17 includes a method of any preceding example 1-14, further comprising: prior to initiating the cell BFR procedure, initiating the TRP BFR procedure for a second beam failure associated with a second TRP of the cell, wherein the TRP BFR procedure includes receiving an uplink grant and sending second BFR information associated with the second beam failure to a network; sending, to the network based on the cell BFR procedure, a truncated media access control (MAC) control element (CE) that includes first BFR information associated with the first beam failure; receiving, after the truncated MAC CE is sent, the uplink grant; and sending, based on the uplink grant, at least a second portion of the second BFR information.

Example 18 includes a method of any preceding example 1-14, further comprising: prior to initiating the cell BFR procedure, initiating the TRP BFR procedure for a second beam failure associated with a second TRP of the cell; and sending, to a network based on the cell BFR procedure, a message that includes first BFR information associated with the first beam failure and second BFR information with the second beam failure.

Example 19 includes a method of any preceding example 1-14, further comprising: prior to initiating the cell BFR procedure, initiating the TRP BFR procedure for a second beam failure associated with a second TRP of the cell, wherein the TRP BFR procedure includes sending second BFR information with the second beam failure to a network; selecting one of first BFR information or the second BFR information to send in a message associated with the cell BFR procedure, wherein the first BFR information is associated with the first beam failure; and sending the message, wherein the message includes the selected one of the first BFR information or the second BFR information.

Example 20 includes a method. The method is implemented by a user equipment (UE). The method comprises: detecting a first beam failure associated with a first transmission and reception point (TRP) of a cell that includes a plurality of TRPs; determining that no uplink grant exists for sending, to a network, first BFR information associated with the first beam failure; determining whether a first TRP beam failure recovery (BFR) procedure is configured for the UE; and sending , to the network based on the determining whether a first TRP BFR is configured, the first BFR information by using the first TRP BFR procedure or a cell BFR procedure.

Example 21 includes a method of example 20, wherein the cell is a secondary cell (SCell), and wherein the first TRP BFR procedure is used instead of the cell BFR procedure based on determining that the TRP BFR is configured for the UE.

Example 22 includes a method of example 20, wherein the cell is a secondary cell (SCell), and wherein the cell BFR procedure is used instead of the first TRP BFR procedure based on determining that the TRP BFR is not configured for the UE.

Example 23 includes a method of example 20, wherein the cell is a secondary cell (SCell), wherein the TRP BFR procedure is used instead of the cell BFR procedure, and wherein the method further comprises: detecting a second beam failure associated with a second TRP of the cell; and initiating a second TRP BFR procedure to send, to the network, second BFR information associated with the second beam failure.

Example 24 includes a method of example 23, wherein the first TRP procedure and the second TRP procedure are used separately to send the first BFR information and the second BFR information separately.

Example 25 includes a method of example 23, further comprising: initiating the first TRP BFR procedure; and canceling, after the first TRP BFR procedure, the second TRP BFR procedure.

Example 26 includes a method of example 25, wherein the first BFR information and the second BFR information are sent using the first TRP BFR procedure.

Example 27 includes a method of example 26, wherein the first BFR information and the second BFR information are sent in a same media access control (MAC) control element (CE) or separate MAC CEs.

Example 28 includes a method. The method is implemented by a user equipment (UE). The method comprises: detecting a first beam failure associated with a first transmission and reception point (TRP) of a cell that includes a plurality of TRPs; generating a media access control (MAC) control element (CE) that indicates first BFR information associated with the first beam failure and second information about a second TRP of the cell; and sending, to a network, the MAC CE for beam failure recovery (BFR).

Example 29 includes a method of example 28, wherein the MAC CE includes a first field associated with the first TRP and a second field associated with the second TRP, wherein the first field indicates the first beam failure, and wherein the second field indicates whether a second beam failure associated with the second TRP is detected.

Example 30 includes a method of example 28, wherein the MAC CE is a truncated MAC CE that includes a first field associated with the first TRP and a second field that includes BFR information associated with the first beam failure.

Example 31 includes a method of example 28, wherein the MAC CE is a truncated MAC CE that includes a first field associated with the first TRP and a second field that excludes BFR information associated with the first beam failure.

Example 32 includes a method of example 28, wherein the MAC CE includes a first field indicating whether a plurality of beam failures are detected for the cell and a second field indicating a TRP index of the first TRP.

Example 33 includes a method of example 28, wherein the MAC CE includes a first field indicating a start of BFR information for beam recovery in the cell and a second field indicating an end of the BFR information.

Example 34 includes a UE comprising means to perform one or more elements of a method described in or related to any of the examples 1-33.

Example 35 includes one or more computer-readable media comprising instructions to cause a UE, upon execution of the instructions by one or more processors of the UE, to perform one or more elements of a method described in or related to any of the examples 1-33.

Example 36 includes a UE comprising logic, modules, or circuitry to perform one or more elements of a method described in or related to any of the examples 1-33.

Example 37 includes a UE comprising: one or more processors and one or more computer-readable media comprising instructions that, when executed by the one or more processors, cause the one or more processors to perform one or more elements of a method described in or related to any of the examples 1-33.

Example 38 includes a system comprising means to perform one or more elements of a method described in or related to any of the examples 1-33.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

Applicant hereby claims:

1. A method implemented by a user equipment (UE), the method comprising: detecting a first beam failure associated with a first transmission and reception point (TRP) of a cell that includes a plurality of TRPs;
determining whether a plurality of beam failures associated with the cell have been detected;
determining whether a TRP beam failure recovery (BFR) procedure is configured for the UE; and
initiating a cell BFR procedure based on the determining whether a plurality of beam failures have been detected and on the determining whether a TRP BFR procedure is configured.

2. The method of claim 1, wherein the cell is a special cell (SpCell) that includes a primary cell (PCell) or a primary secondary cell group cell (PSCell), and wherein the cell BFR procedure is performed upon determining that the plurality of beam failures are detected and upon determining that the TRP BFR procedure is configured for the UE and has been initiated in association with a second TRP but has not been completed yet.

3. The method of claim 1, wherein the TRP BFR procedure is configured for the UE based on configuration information, wherein the configuration information includes BFR special request (BFR-SR) resource on a physical uplink control channel (PUCCH).

4. The method of claim 1, wherein the cell is a special cell (SpCell) that includes a primary cell (PCell) or a primary secondary cell group cell (PSCell), and wherein the cell BFR procedure is performed upon determining that only one beam failure is detected and determining that no TRP BFR procedure is configured for the UE.

5. The method of claim 1, wherein the cell is a special cell (SpCell) that includes a primary cell (PCell) or a primary secondary cell group cell (PSCell), and wherein the cell BFR procedure is performed upon determining that a second beam failure associated with a second TRP of the cell is detected and upon determining that the TRP BFR procedure is configured for the UE based on configuration information associated with the second TRP and not the first TRP.

6. The method of claim 1, further comprising:
canceling the cell BFR procedure.

7. The method of claim 1, further comprising:
determining, after the cell BFR procedure is initiated, an opportunity to send first BFR information associated with the first beam failure to a network; and
canceling, based on the opportunity, the cell BFR procedure.

8. The method of claim 7, further comprising:
initiating the TRP BFR procedure for a second beam failure associated with a second TRP of the cell;
receiving an uplink grant based on the TRP BFR procedure; and
sending, to the network based on the uplink grant, a media access control (MAC) control element (CE), wherein the opportunity includes the sending of the MAC CE.

9. The method of claim 8, wherein the uplink grant is received after the cell BFR procedure is initiated and before the MAC CE is sent, wherein the MAC CE includes the first BFR information and second BFR information associated with the second beam failure.

10. The method of claim 8, wherein the uplink grant is received after the cell BFR procedure is initiated and after the MAC CE is sent, wherein the MAC CE includes second BFR information associated with the second beam failure, and wherein the method further comprises:
sending another MAC CE that includes the first BFR information.

11. The method of claim 7, further comprising:
receiving, after the cell BFR procedure is initiated, an uplink grant; and
sending, to the network based on the uplink grant, a media access control (MAC) control element (CE) that includes the first BFR information, wherein the opportunity includes the sending of the MAC CE.

12. The method of claim 1, further comprising:
prior to initiating the cell BFR procedure, initiating the TRP BFR procedure for a second beam failure associated with a second TRP of the cell; and
canceling the TRP BFR procedure based on the initiating of the cell BFR procedure.

13. The method of claim 12, wherein the TRP BFR procedure includes receiving an uplink grant and sending, based on the uplink grant, BFR information associated with the first beam failure to a network, and wherein the TRP BFR procedure is canceled after the cell BFR procedure is initiated and before the BFR information is sent.

14. The method of claim 12, wherein the TRP BFR procedure includes receiving an uplink grant and sending, based on the uplink grant, BFR information associated with the first beam failure to a network, and wherein the TRP BFR procedure is canceled after the cell BFR procedure is initiated and after the BFR information is sent.

15. The method of claim 1, further comprising:
prior to initiating the cell BFR procedure, initiating the TRP BFR procedure for a second beam failure associated with a second TRP of the cell;
sending, based on the TRP BFR procedure, second BFR information associated with the second beam failure to a network; and
sending, based on the cell BFR procedure, first BFR information associated with the first beam failure to the network.

16. The method of claim 15, wherein the first BFR information is sent in a message of the cell BFR procedure, and wherein the message indicates that the second BFR information has been previously sent.

17. The method of claim 1, further comprising:
prior to initiating the cell BFR procedure, initiating the TRP BFR procedure for a second beam failure associated with a second TRP of the cell, wherein the TRP BFR procedure includes receiving an uplink grant and sending second BFR information associated with the second beam failure to a network;
sending, to the network based on the cell BFR procedure, a truncated media access control (MAC) control element (CE) that includes first BFR information associated with the first beam failure;
receiving, after the truncated MAC CE is sent, the uplink grant; and
sending, based on the uplink grant, at least a second portion of the second BFR information.

18. The method of claim 1, further comprising:
prior to initiating the cell BFR procedure, initiating the TRP BFR procedure for a second beam failure associated with a second TRP of the cell; and
sending, to a network based on the cell BFR procedure, a message that includes first BFR information associated with the first beam failure and second BFR information with the second beam failure.

19. The method of claim 1, further comprising:
prior to initiating the cell BFR procedure, initiating the TRP BFR procedure for a second beam failure associated with a second TRP of the cell, wherein the TRP BFR procedure includes sending second BFR information with the second beam failure to a network;
selecting one of first BFR information or the second BFR information to send in a message associated with the cell BFR procedure, wherein the first BFR information is associated with the first beam failure; and
sending the message, wherein the message includes the selected one of the first BFR information or the second BFR information.

20. A user equipment (UE) comprising:
one or more processors; and
one or more memory storing computer-readable instructions that, upon execution by the one or more processors, configure the UE to:
detect a first beam failure associated with a first transmission and reception point (TRP) of a cell that includes a plurality of TRPs;
determine that no uplink grant exists for sending, to a network, first BFR information associated with the first beam failure;
determine whether a first TRP beam failure recovery (BFR) procedure is configured for the UE; and
send, to the network based on the determining whether a first TRP BFR is configured, the first BFR information by using the first TRP BFR procedure or a cell BFR procedure.

21. The UE of claim 20, wherein the cell is a secondary cell (SCell), and wherein the first TRP BFR procedure is used instead of the cell BFR procedure based on determining that the TRP BFR is configured for the UE.

22. The UE of claim 20, wherein the cell is a secondary cell (SCell), and wherein the cell BFR procedure is used instead of the first TRP BFR procedure based on determining that the TRP BFR is not configured for the UE.

23. The UE of claim 20, wherein the cell is a secondary cell (SCell), wherein the TRP BFR procedure is used instead of the cell BFR procedure, and wherein the execution of the computer-readable instructions further configures the UE to:
detect a second beam failure associated with a second TRP of the cell; and
initiate a second TRP BFR procedure to send, to the network, second BFR information associated with the second beam failure.

24. The UE of claim 23, wherein the first TRP procedure and the second TRP procedure are used separately to send the first BFR information and the second BFR information separately.

25. The UE of claim 23, wherein the execution of the computer-readable instructions further configures the UE to:
initiate the first TRP BFR procedure; and
cancel, after the first TRP BFR procedure, the second TRP BFR procedure.

26. The UE of claim 25, wherein the first BFR information and the second BFR information are sent using the first TRP BFR procedure.

27. The UE of claim 26, wherein the first BFR information and the second BFR information are sent in a same media access control (MAC) control element (CE) or separate MAC CEs.

28. One or more computer-readable storage media storing instructions that, upon execution on a user equipment (UE), cause the UE to perform operations that comprise:
detecting a first beam failure associated with a first transmission and reception point (TRP) of a cell that includes a plurality of TRPs;
generating a media access control (MAC) control element (CE) that indicates first BFR information associated with the first beam failure and second information about a second TRP of the cell; and
sending, to a network, the MAC CE for beam failure recovery (BFR).

29. The one or more computer-readable storage media of claim 28, wherein the MAC CE includes a first field associated with the first TRP and a second field associated with the second TRP, wherein the first field indicates the first beam failure, and wherein the second field indicates whether a second beam failure associated with the second TRP is detected.

30. The one or more computer-readable storage media of claim 28, wherein the MAC CE is a truncated MAC CE that includes a first field associated with the first TRP and a second field that includes BFR information associated with the first beam failure.

31. The one or more computer-readable storage media of claim 28, wherein the MAC CE is a truncated MAC CE that includes a first field associated with the first TRP and a second field that excludes BFR information associated with the first beam failure.

32. The one or more computer-readable storage media of claim 28, wherein the MAC CE includes a first field indicating whether a plurality of beam failures are detected for the cell and a second field indicating a TRP index of the first TRP.

33. The one or more computer-readable storage media of claim 28, wherein the MAC CE includes a first field indicating a start of BFR information for beam recovery in the cell and a second field indicating an end of the BFR information.
